(19) United States
(12) Patent Application Publication
(10) Pub. No.: US 2021/0398528 A1
(43) Pub. Date: Dec. 23, 2021

(54) METHOD FOR DISPLAYING CONTENT IN RESPONSE TO SPEECH COMMAND, AND ELECTRONIC DEVICE THEREFOR

(71) Applicant: Samsung Electronics Co., Ltd., Gyeonggi-do (KR)

(72) Inventors: Minsoo KIM, Gyeonggi-do (KR); Yohan LEE, Gyeonggi-do (KR); Sanghee PARK, Gyeonggi-do (KR); Kyoungwoon KIM, Gyeonggi-do (KR); Doosuk KANG, Gyeonggi-do (KR); Sunkee LEE, Gyeonggi-do (KR)

(21) Appl. No.: 17/289,797

(22) PCT Filed: Oct. 7, 2019
(86) PCT No.: PCT/KR2019/013087

§ 371 Date: Apr. 29, 2021

(30) Foreign Application Priority Data
Oct. 31, 2018 (KR) 10-2018-0131790

(51) Int. Cl. G10L 15/22; G06F 3/16

(52) U.S. Cl. CPC G10L 15/22; G10L 2015/225; G10L 2015/223; G06F 3/167

(57) ABSTRACT

Various embodiments of the present invention are to display a content in response to a speech command. An electronic device according thereto may comprise: a communication module; a processor operably connected to the communication module; and a memory operably connected to the processor. The memory may store instructions which, when executed, cause the processor to: receive, through the communication module, information relating to the contents of a speechmaker's speech command acquired by an external electronic device; search the vicinities of the speechmaker for one or more display devices based on the location of the speechmaker and the location of the external electronic device identified by using measurement information concerning the speech command; select, from the one or more display devices, a display device to display a content as a response to the speech command; and display the content through the selected display device based on at least one of the speechmaker's state, the states of the speechmaker's surroundings, and the properties of the content. Various other embodiments are also possible.

### TECHNICAL FIELD

Various embodiments of the present disclosure relate to a method for displaying a content in response to a speech command, and a device therefor.

### BACKGROUND ART

Owing to the growth of technologies, various products helpful for a convenience of life are being developed. In an example, recently, a device recognizing a human's speech and performing a specific function according to the recognized speech has been ever commercialized. For example, various operations can be provided such as playing specific music or searching information such as weather, etc. by a speech command. Through this device, a user can forward a command immediately and fast by using saying, and obtain a desired result.

In general, a device providing the aforementioned service is designed based on a dialogue. Accordingly, a feedback corresponding to a speech command chiefly takes the form of an audio. Accordingly to this, there can be a limitation in a provision scheme of a content provided as the feedback, or the type of an available content.

### DISCLOSURE OF INVENTION

### Technical Problem

In general, a conventional speech based dialogue type response service merely analyzes the contents of a user's speech command, and outputs information corresponding to this. Accordingly, even when an optimal feedback scheme is varied according to a user's state or a situation which a user is in, these factors may not be taken into consideration.

Various embodiments of the present disclosure can provide a method for providing more optimized response in consideration of various situations such as a user's state, etc., and an electronic device therefor.

### Solution to Problem

According to various embodiments of the present disclosure, an electronic device can include a communication module, a processor operably connected to the communication module, and a memory operably connected to the processor. The memory can store instructions which, when executed, cause the processor to receive, through the communication module, information relating to the contents of a speechmaker's speech command acquired by an external electronic device, and search the vicinities of the speechmaker for one or more display devices based on the location of the speechmaker determined by using measurement information concerning the speech command, and the location of the external electronic device, and determine, from the one or more display devices, a display device to display a content as a response to the speech command, and display the content through the determined display device based on at least one of the speechmaker's state, the states of the speechmaker's surroundings, and the properties of the content.

According to various embodiments of the present disclosure, an electronic device can include a display, a communication module, a processor operably connected to the display and the communication module, and a memory operably connected to the processor. The memory can store instructions which, when executed, cause the processor to receive an indication message for displaying of a content and the content as a response to a speechmaker's speech command acquired by an external electronic device, and display the content based on at least one of the speechmaker's state, the states of the speechmaker's surroundings, and the properties of the content, through the display, based on the indication message.

According to various embodiments of the present disclosure, an operating method of an electronic device can include receiving information relating to the contents of a speechmaker's speech command acquired by an external electronic device, and searching the vicinities of the speechmaker for one or more display devices based on the location of the speechmaker determined by using measurement information concerning the speech command, and the location of the external electronic device, and determining, from the one or more display devices, a display device to display a content as a response to the speech command, and controlling the determined display device to display the content. Here, a displaying level of the content can be determined based on at least one of the speechmaker's state, the states of the speechmaker's surroundings, and the properties of the content.

### Advantageous Effects of Invention

A method of various embodiments and an electronic device therefor can more effectively provide a content desired by a user, by adjusting a display scheme of a content in consideration of various situations such as a user's state of presenting a speech command, the location of the user, or the properties of the content.

### BRIEF DESCRIPTION OF DRAWINGS

FIG. 1 is a block diagram of an electronic device within a network environment, according to various embodiments.

FIG. 2A is a block diagram illustrating an integrated intelligence system according to an embodiment.

FIG. 2B is a diagram illustrating a form in which concept and action relationship information is stored in a database, according to an embodiment.

FIG. 2C is a diagram illustrating a user terminal displaying a screen processing a voice input received through an intelligence app, in accordance with an embodiment.

FIG. 3 is a diagram illustrating an example of an environment offering a content in response to a speech command according to various embodiments.

FIG. 4 is a diagram illustrating another example of an environment offering a content in response to a speech command according to various embodiments.

FIG. 5 is a block diagram of a speech receiving device receiving a speech command in accordance with various embodiments.

FIG. 6 is a block diagram of a device control server controlling to offer a content in response to a speech command in accordance with various embodiments.

FIG. 7 is a diagram illustrating a signal exchange procedure for offering a content in response to a speech command in accordance with various embodiments.

FIG. 8 is a flowchart for controlling to offer a content in response to a speech command in a device control server according to various embodiments.

FIG. 9 is a flowchart for estimating the location of a speechmaker in a device control server according to various embodiments.

FIG. 10 is a diagram illustrating a relative location relationship between a speechmaker and microphones according to various embodiments.

FIG. 11 is a flowchart for selecting a display device in a device control server according to various embodiments.

FIG. 12 is a flowchart for identifying display devices of the vicinities of a speechmaker in a device control server according to various embodiments.

FIG. 13 is a diagram illustrating an example of a peripheral device of a speech receiving device according to various embodiments.

FIG. 14 is a flowchart for estimating the location of a speechmaker in a device control server according to various embodiments.

FIG. 15 is a diagram illustrating an example in which a plurality of speech receiving devices are arranged according to various embodiments.

FIG. 16 is a flowchart for forwarding a content corresponding to a speech command in a device control server according to various embodiments.

FIG. 17 is a flowchart for determining a level of a content in a device control server according to various embodiments.

FIG. 18 is a block diagram of a display device displaying a content in accordance with various embodiments.

FIG. 19 is a flowchart for displaying a content in a display device according to various embodiments.

FIG. 20A and FIG. 20B are diagrams illustrating an example of a size change of a content displayed in a display device according to various embodiments.

FIG. 21A and FIG. 21B are diagrams illustrating another example of a size change of a content displayed in a display device according to various embodiments.

FIG. 22A, FIG. 22B and FIG. 22C are diagrams illustrating examples of various expression schemes of a content displayed in a display device according to various embodiments.

FIG. 23A, FIG. 23B, FIG. 23C and FIG. 23D are diagrams illustrating other examples of various expression schemes of a content displayed in a display device according to various embodiments.

FIG. 24A and FIG. 24B are diagrams illustrating an example of a form change of a content displayed in a display device according to various embodiments.

FIG. 25 is a flowchart for displaying a content in consideration of time in a display device according to various embodiments.

FIG. 26A and FIG. 26B are diagrams illustrating an example of a change dependent on a time flow of a content displayed in a display device according to various embodiments.

FIG. 27A and FIG. 27B are diagrams illustrating a further example of a size change of a content displayed in a display device according to various embodiments.

FIG. 28A and FIG. 28B are diagrams illustrating an example of a change of the display or non-display of a content displayed in a display device according to various embodiments.

FIG. 29A and FIG. 29B are diagrams illustrating an example of a content including identification information about a source according to various embodiments.

FIG. 30A and FIG. 30B are diagrams illustrating an example of a change of a content considering an angle with a speechmaker according to various embodiments.

### BEST MODE FOR CARRYING OUT THE INVENTION

Various embodiments are described below in detail with reference to the accompanying drawings.

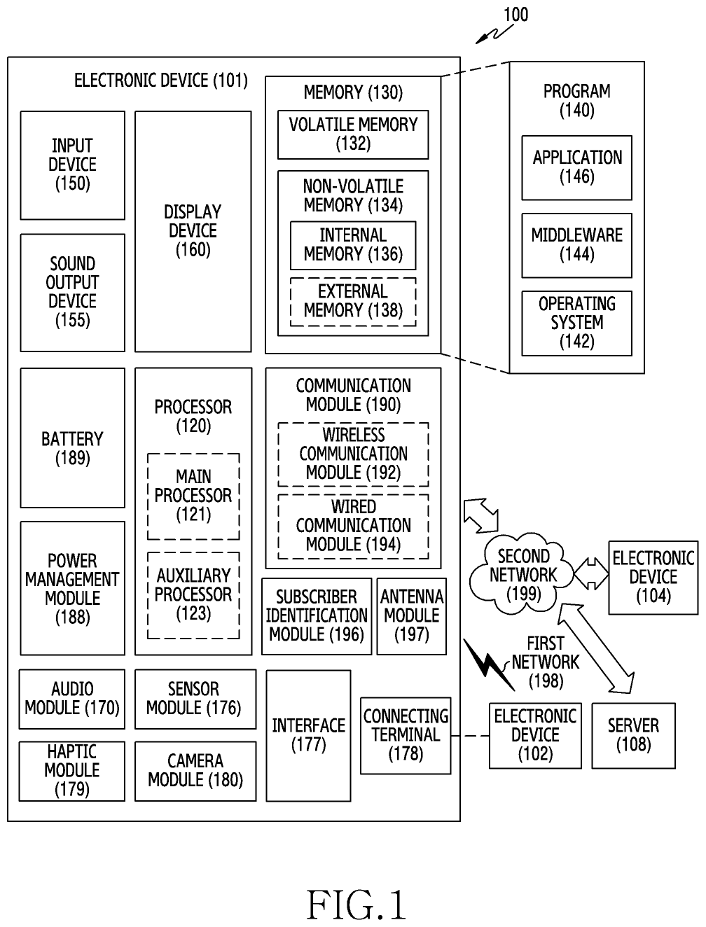

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

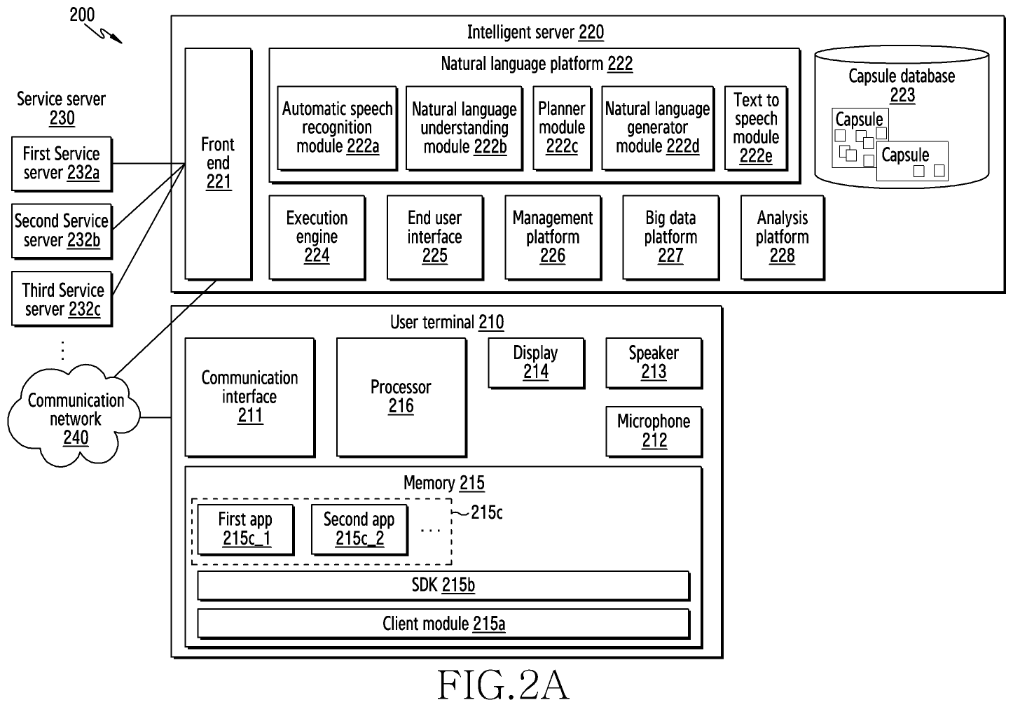

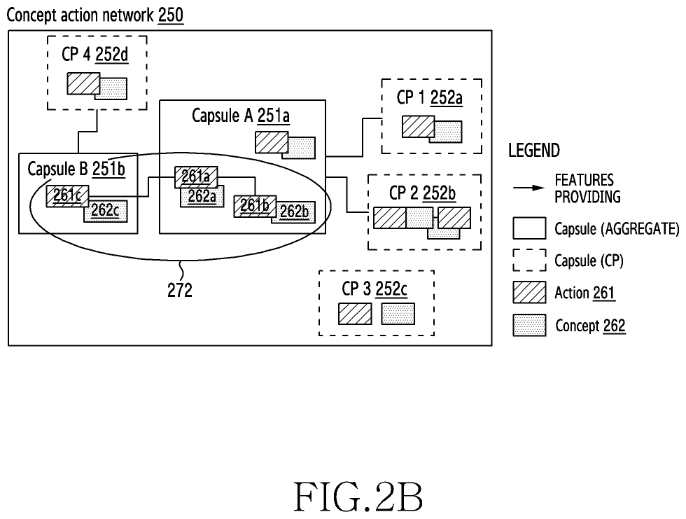

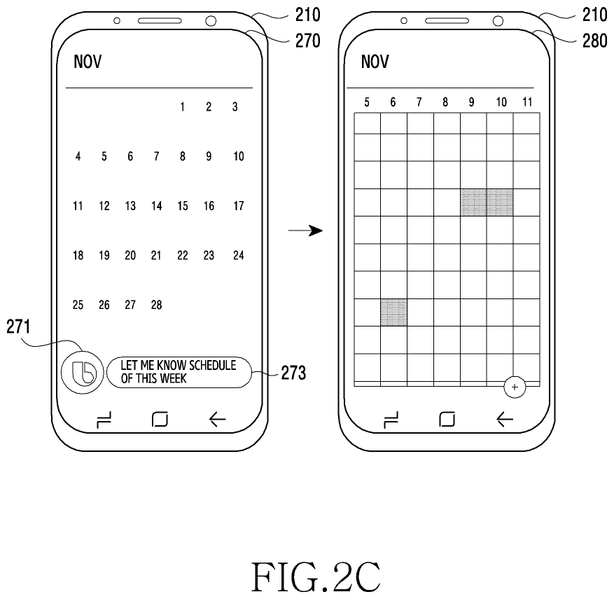

FIG. 2A is a block diagram illustrating an integrated intelligence system according to an embodiment.

Referring to FIG. 2A, the integrated intelligence system 200 of an embodiment can include a user terminal 210 (e.g., the electronic device 101 of FIG. 1), an intelligent server 220, and a service server 230.

The user terminal 210 of an embodiment can be a terminal device (or an electronic device) connectable to the Internet, and can be, for example, a portable phone, a smart phone, a personal digital assistant (PDA), a notebook computer, a television (TV), a home appliance, a wearable device, a head mounted device (HMD), or a smart speaker.

According to an embodiment, the user terminal 210 can include a communication interface 211, a microphone 212, a speaker 213, a display 214, a memory 215, or a processor 216. The enumerated components can be mutually operably or electrically connected.

According to an embodiment, the communication interface 211 can be configured to connect with an external device and transmit and/or receive data. According to an embodiment, the microphone 212 can receive a sound (e.g., a user utterance), and convert the same into an electrical signal. According to an embodiment, the speaker 213 can output the electrical signal by a sound (e.g., a voice). According to an embodiment, the display 214 can be configured to display an image or video. According to an embodiment, the display 214 can display a graphic user interface (GUI) of an executed app (or application program).

According to an embodiment, the memory 215 can store a client module 215a, a software development kit (SDK) 215b, and a plurality of apps 215c. The client module 215a and the SDK 215b can configure a framework (or a solution program) for performing a generic function. Also, the client module 215a or the SDK 215b can configure a framework for processing a voice input.

According to an embodiment, the plurality of apps 215c stored in the memory 215 can be a program for performing a specified function. According to an embodiment, the plurality of apps 215c can include a first app 215c_1 and a second app 215c_2. According to an embodiment, the plurality of apps 215c can each include a plurality of actions for performing a specified function. For example, the plurality of apps 215c can include at least one of an alarm app, a message app, and a schedule app. According to an embodiment, the plurality of apps 215c can be executed by the processor 216, and execute at least some of the plurality of actions in sequence.

According to an embodiment, the processor 216 can control general operations of the user terminal 210. For example, the processor 216 can be electrically connected with the communication interface 211, the microphone 212, the speaker 213, the display 214, and the memory 215, and perform a specified operation.

According to an embodiment, the processor 216 can also execute a program stored in the memory 215, and perform a specified function. For example, by executing at least one of the client module 215a or the SDK 215b, the processor 216 can perform the following operation for processing a voice input. The processor 216 can, for example, control operations of the plurality of apps 215c through the SDK 215b. The following operation explained as an operation of the client module 215a or the SDK 215b can be an operation by the execution of the processor 216.

According to an embodiment, the client module 215a can receive a voice input. For example, the client module 215a can provide a voice signal corresponding to a user utterance which is obtained through the microphone 212. The client module 215a can send the received voice input to the intelligent server 220. According to an embodiment, the client module 215a can send, together with the received voice input, state information of the user terminal 210 to the intelligent server 220. The state information can be, for example, app execution state information.

According to an embodiment, the client module 215a can receive a result corresponding to the received voice input. For example, the client module 215a can receive a result corresponding to the voice input from the intelligent server 220. The client module 215a can display the received result on the display 214.

According to an embodiment, the client module 215a can receive a plan corresponding to the received voice input. The client module 215a can display, on the display 214, results of executing a plurality of actions of an app according to the plan. For example, the client module 215a can display, on the display, the results of execution of the plurality of actions in sequence. For another example, the user terminal 210 can display only some results (e.g., a result of the last operation) of executing the plurality of actions on the display.

According to an embodiment, the client module 215a can receive, from the intelligent server 220, a request for acquiring information necessary for calculating a result corresponding to a voice input. The information necessary for calculating the result, for example, can be state information of the user terminal 210. According to an embodiment, in response to the request, the client module 215a can send the necessary information to the intelligent server 220.

According to an embodiment, the client module 215a can send result information executing a plurality of actions according to a plan, to the intelligent server 220. By using the result information, the intelligent server 220 can confirm that the received voice input is processed rightly.

According to an embodiment, the client module 215a can include a speech recognition module. According to an embodiment, the client module 215a can recognize a voice input of performing a limited function, through the speech recognition module. For example, the client module 215a can perform an intelligent app for processing a voice input for performing an organic operation through a specified input (e.g., wake up!).

According to an embodiment, the intelligent server 220 can receive information related with a user voice input from the user terminal 210 through a communication network 240. According to an embodiment, the intelligent server 220 can change received data related with the voice input into text data. According to an embodiment, the intelligent server 220 can provide a plan for performing a task corresponding to the user voice input on the basis of the text data.

According to an embodiment, the plan can be provided by an artificial intelligent (AI) system. The artificial intelligent (AI) system can be a rule-based system as well, and can be a neural network-based system (e.g., feedforward neural network (FNN) and/or a recurrent neural network (RNN)) as well. Or, the artificial intelligent system can be a combination of the aforementioned or an artificial intelligent system different from this as well. According to an embodiment, the plan can be selected from a set of previously defined plans, or can be provided in real time in response to a user request. For example, the artificial intelligent system can select at least a plan among a previously defined plurality of plans.

According to an embodiment, the intelligent server 220 can send a result calculated according to the provided plan to the user terminal 210 or can send the provided plan to the user terminal 210. According to an embodiment, the user terminal 210 can display the result calculated according to the plan on the display. According to an embodiment, the user terminal 210 can display a result of executing an operation associated with the plan on the display.

The intelligent server 220 of an embodiment can include a front end 221, a natural language platform 222, a capsule database (DB) 223, an execution engine 224, an end user interface 225, a management platform 226, a big data platform 227, and an analytic platform 228.

According to an embodiment, the front end 221 can receive a voice input received from the user terminal 210. The front end 221 can send a response corresponding to the voice input.

According to an embodiment, the natural language platform 222 can include an automatic speech recognition module (ASR module) 222a, a natural language understanding module (NLU module) 222b, a planner module 222c, a natural language generator module (NLG module) 222d, and a text to speech module (TTS module) 222e.

According to an embodiment, the automatic speech recognition module 222a can convert a voice input received from the user terminal 210, into text data. According to an embodiment, the natural language understanding module 222b can grasp a user intention by using the text data of the voice input. For example, the natural language understanding module 222b can perform syntactic analysis or semantic analysis, to grasp the user intention. According to an embodiment, the natural language understanding module 222b can grasp a meaning of a word extracted from the voice input by using a linguistic feature (e.g., syntactic factor) of a morpheme or phrase, and match the grasped meaning of the word with an intention, to determine the user intention.

According to an embodiment, the planner module 222c can provide a plan by using an intention determined by the natural language understanding module 222b and a parameter. According to an embodiment, the planner module 222c can determine a plurality of domains necessary for performing a task, on the basis of the determined intention. The planner module 222c can determine a plurality of actions which are included in each of the plurality of domains determined on the basis of the intention. According to an embodiment, the planner module 222c can determine a parameter necessary for executing the determined plurality of actions, or a result value outputted by the execution of the plurality of actions. The parameter and the result value can be defined by a concept related to a specified form (or class). Accordingly to this, the plan can include the plurality of actions determined by the user intention, and a plurality of concepts. The planner module 222c can determine relationships between the plurality of actions and the plurality of concepts, stepwise (or hierarchically). For example, the planner module 222c can determine, on the basis of the plurality of concepts, a sequence of execution of the plurality of actions determined on the basis of the user intention. In other words, the planner module 222c can determine a sequence of execution of the plurality of actions, on the basis of the parameter necessary for execution of the plurality of actions and the result outputted by execution of the plurality of actions. Accordingly to this, the planner module 222c can provide a plan including association information (e.g., ontology) between the plurality of actions and the plurality of concepts. The planner module 222c can provide the plan by using information stored in the capsule database 223 storing a set of relationships of the concepts and the actions.

According to an embodiment, the natural language generator module 222d can change specified information into a text form. The information changed into the text form can be a form of a natural language utterance. The text to speech module 222e of an embodiment can change information of the text form into information of a speech form.

According to an embodiment, the capsule database 223 can store information about relationships of a plurality of concepts and actions which correspond to a plurality of domains. For example, the capsule database 223 can store a plurality of capsules which include a plurality of action objects (or action information) and concept objects (or concept information) of a plan. According to an embodiment, the capsule database 223 can store the plurality of capsules in the form of a concept action network (CAN). According to an embodiment, the plurality of capsules can be stored in a function registry included in the capsule database 223.

According to an embodiment, the capsule database 223 can include a strategy registry which stores strategy information which is necessary when determining a plan corresponding to a voice input. The strategy information can include reference information for determining one plan in response to there being a plurality of plans corresponding to the voice input. According to an embodiment, the capsule database 223 can include a follow up registry which stores follow-up action information for proposing a follow-up action to a user in a specified situation. The follow-up action, for example, can include a follow-up utterance. According to an embodiment, the capsule database 223 can include a layout registry which stores layout information of information outputted through the user terminal 210. According to an embodiment, the capsule database 223 can include a vocabulary registry which stores vocabulary information included in capsule information. According to an embodiment, the capsule database 223 can include a dialog registry which stores dialog (or interaction) information with a user.

According to an embodiment, the capsule database 223 can refine a stored object through a developer tool. The developer tool can, for example, include a function editor for refining an action object or a concept object. The developer tool can include a vocabulary editor for refining a vocabulary. The developer tool can include a strategy editor which provides and registers a strategy of determining a plan. The developer tool can include a dialog editor for providing a dialog with a user. The developer tool can include a follow up editor capable of activating a follow-up target, and editing a follow-up utterance offering a hint. The follow-up target can be determined on the basis of a currently set target, a user's preference or an environment condition.

According to an embodiment, the capsule database 223 can be implemented even within the user terminal 210. In other words, the user terminal 210 can include the capsule database 223 which stores information for determining an operation corresponding to a voice input.

According to an embodiment, the execution engine 224 can calculate a result by using the provided plan. According to an embodiment, the end user interface 225 can send the calculated result to the user terminal 210. Accordingly to this, the user terminal 210 can receive the result, and offer the received result to a user. According to an embodiment, the management platform 226 can manage information used in the intelligent server 220. According to an embodiment, the big data platform 227 can collect user data. According to an embodiment, the analytic platform 228 can manage a quality of service (QoS) of the intelligent server 220. For example, the analytic platform 228 can manage a component, and a processing speed (or efficiency), of the intelligent server 220.

According to an embodiment, the service server 230 can offer a specified service (e.g., food order or hotel reservation) to the user terminal 210. According to an embodiment, the service server 230 can be a server managed by a third party. For example, the service server 230 can include a first service server 232a, a second service server 232b, and a third service server 232c which are managed by mutually different third parties. According to an embodiment, the service server 230 can offer information for providing a plan corresponding to a received voice input, to the intelligent server 220. The offered information, for example, can be stored in the capsule database 223. Also, the service server 230 can offer result information associated with the plan to the intelligent server 220.

In the above-described integrated intelligence system 200, the user terminal 210 can, in response to a user input, offer various intelligent services to a user. The user input, for example, can include an input through a physical button, a touch input, or a voice input.

In an embodiment, the user terminal 210 can offer a speech recognition service through an intelligent app (or a speech recognition app) stored therein. In this case, for example, the user terminal 210 can recognize a user utterance or voice input received through the microphone, and offer a service corresponding to the recognized voice input to a user.

According to an embodiment, the user terminal 210 can perform a specified operation, singly or together with the intelligent server and/or the service server, on the basis of the received voice input. For example, the user terminal 210 can execute an app corresponding to the received voice input, and perform a specified operation through the executed app.

According to an embodiment, in response to the user terminal 210 offering a service together with the intelligent server 220 and/or the service server, the user terminal can obtain a user utterance by using the microphone 212, and provide a signal (or voice data) corresponding to the obtained user utterance. The user terminal can send the voice data to the intelligent server 220 by using the communication interface 211.

According to an embodiment, the intelligent server 220 can, as a response to a voice input received from the user terminal 210, provide a plan for performing a task corresponding to the voice input, or a result of performing an operation according to the plan. The plan can include, for example, a plurality of actions for performing a task corresponding to the user's voice input, and a plurality of concepts related with the plurality of actions. The concept can be a definition of a parameter inputted for the execution of the plurality of actions, or a result value outputted by the execution of the plurality of actions. The plan can include association information between the plurality of actions and the plurality of concepts.

The user terminal 210 of an embodiment can receive the response by using the communication interface 211. The user terminal 210 can output a voice signal provided within the user terminal 210 to the external by using the speaker 213, or output an image provided within the user terminal 210 to the external by using the display 214.

FIG. 2B is a diagram illustrating a form in which relationship information of a concept and an action is stored in a database, according to various embodiments.

A capsule database (e.g., the capsule database 223) of the intelligent server 220 can store a plurality of capsules in the form of a concept action network (CAN) 250. The capsule database can store an action for processing a task corresponding to a user's voice input, and a parameter necessary for the action, in the form of the concept action network (CAN). The CAN can represent an organic relationship between an action and a concept defining a parameter necessary for performing the action.

The capsule database can store a plurality of capsules (e.g., a capsule A 251a and a capsule B 251b) corresponding to each of a plurality of domains (e.g., applications). According to an embodiment, one capsule (e.g., the capsule A 251a) can correspond to one domain (e.g., application). Also, one capsule can correspond to at least one service provider (e.g., CP 1 252a, CP 2 252b, CP 3 252c, or CP 4 252d) for performing a function of a domain related to a capsule. According to an embodiment, one capsule can include at least one or more actions 261 for performing a specified function and at least one or more concepts 262.

According to an embodiment, the natural language platform 222 can provide a plan for performing a task corresponding to a received voice input, by using the capsule stored in the capsule database. For example, the planner module 222c of the natural language platform can provide the plan by using the capsule stored in the capsule database. For example, it can provide a plan 272 by using actions 261a and 261b and concepts 262a and 262b of the capsule A 251a, and an action 261c and a concept 262c of the capsule B 251b.

FIG. 2C is a diagram illustrating a screen in which a user terminal processes a received voice input through an intelligent app according to various embodiments.

To process a user input through the intelligent server 220, the user terminal 210 can execute the intelligent app.

According to an embodiment, in screen 270, in response to recognizing a specified voice input (e.g., wake up!) or receiving an input through a hardware key (e.g., a dedicated hardware key), the user terminal 210 can execute the intelligent app for processing the voice input. The user terminal 210 can, for example, execute the intelligent app in a state of executing a schedule app. According to an embodiment, the user terminal 210 can display, on the display 214, an object (e.g., icon) 271 corresponding to the intelligent app. According to an embodiment, the user terminal 210 can receive a voice input by a user utterance. For example, the user terminal 210 can receive a voice input “Let me know a schedule of this week!”. According to an embodiment, the user terminal 210 can display, on the display, a user interface (UI) 273 (e.g., an input window) of the intelligent app which displays text data of the received voice input.

According to an embodiment, in screen 280, the user terminal 210 can display a result corresponding to the received voice input on the display. For example, the user terminal 210 can receive a plan corresponding to the received user input, and display ‘schedule of this week’ on the display according to the plan.

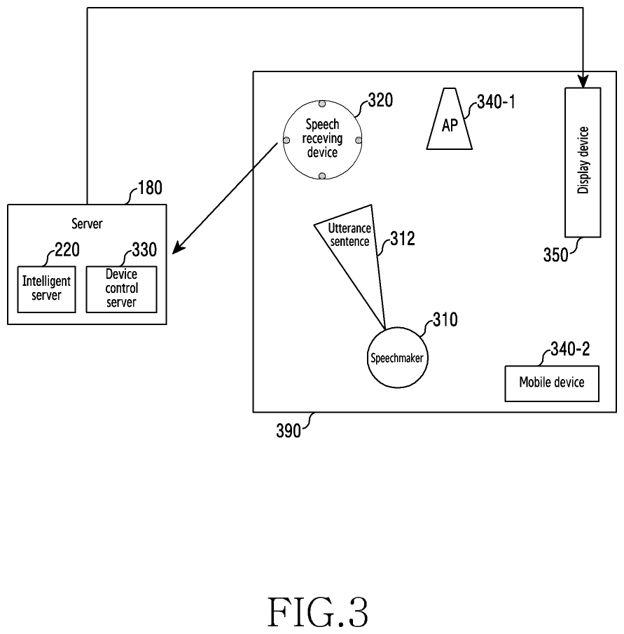

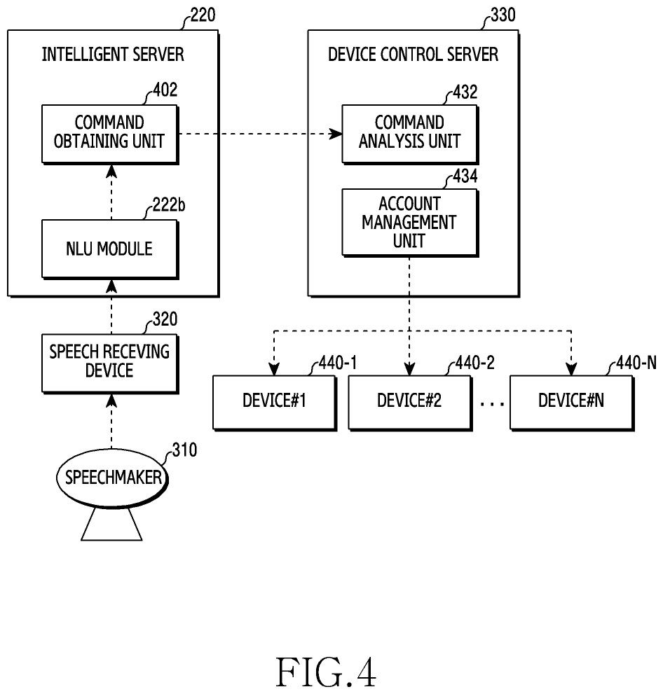

Various embodiments described later relate to a service of performing an operation accompanied by a user's speech command by using NLU. NLU is generally a technology for changing an obtained speech into a text corresponding to the speech. When data changed into the text is an operation for a specific device, a device according to various embodiments of the present disclosure finds out an operation corresponding to a text for the corresponding device, and forwards the same to the device. The present disclosure considers a case that a device receiving a speech command, a server determining the command, and a device performing the command are different devices, as in FIG. 3 or FIG. 4 below.

FIG. 3 is a diagram illustrating an example of an environment of offering a content in response to a speech command according to various embodiments.

Referring to FIG. 3, a speechmaker 310 can be located in a given space 390 (e.g., a room), and a speech receiving device 320 can be installed in the space 390. Various devices such as an access point (AP) 340-1, a display device 350 and/or a mobile device 340-2 (e.g., a smart phone) can be installed in the space 390. The AP 340-1, the display device 350, and the mobile device 340-2 can form a home network. A server 180 can be located outside the space 390, and include an intelligence server 220 analyzing an utterance sentence 312 and a device control server 330 controlling devices within the space 390. The server 180 can perform communication with the AP 340-1, the display device 350 and the mobile device 340-2 which are installed in the space 390, and can control operations of the AP 340-1, the display device 350 and the mobile device 340-2. For example, in response to the speech receiving device 320 receiving the utterance sentence 312 of the speechmaker 310, the server 180 can control the display device 340 installed in the space 390 to display a response corresponding to a speech command offered from the speech receiving device 320.

FIG. 4 is a diagram illustrating another example of an environment of offering a content in response to a speech command according to various embodiments.

Referring to FIG. 4, a speech command provided by the speechmaker 310 can be received by the speech receiving device 320 installed near the speechmaker 310. Prior to this, the speech receiving device 320 can operate in a mode capable of recognizing a general speech command as receiving a speech of a predefined pattern of activating or waking up the speech receiving device 320, during a power off or low power mode operation. Accordingly, after the speechmaker 310 firstly utters a predefined speech command (e.g., a predefined word or sentence) for activating the speech receiving device 320, the speechmaker 310 can utter a speech command of contents desired to be executed.

The speech receiving device 320 can transmit the received speech command to the intelligence server 220. The speech command can be transmitted in the form of data expressing a waveform of a voice. The intelligence server 220 can grasp the contents of the speech command, and transmit the grasped contents of the speech command to the device control server 330. The speech receiving device 320 can be a separate product having a housing, or be implemented as a module not including a housing. In response to the speech receiving device 320 being implemented as the module, the speech receiving device 320 can be installed in other devices (e.g., a phone, a TV or a computer) or other products (e.g., furniture or a flower pot).

The intelligence server 220 can include an NLU module 222b and a command providing unit 402. The NLU module 222b can grasp the contents of a speech command converted into a text, and the command providing unit 402 can provide an instruction having a form interpretable by the device control server 330 based on the contents of the speech command grasped by the NLU module 222b, and transmit the instruction to the device control server 330. For example, the instruction can include one or more keywords (e.g., weather, a schedule, or searching) notifying the contents of a command, and/or one or more keywords (e.g., displaying, an image, or a video) notifying the form of a content. The intelligence server 220 can be called a ‘voice assistance server’.

The device control server 330 can control operations of various devices (e.g., device #1 440-1, device #2 440-2, . . . , device #N 440-N). The device control server 330 can control the devices so as to collect information about a speechmaker and the vicinities of the speechmaker, or so as to output a content. The device control server 330 can include a command analysis unit 432 and an account management unit 434. By interpreting an instruction received from the intelligence server 220, the command analysis unit 432 can identify the contents of a speech command. The account management unit 434 can manage information (e.g., identification information, capability information, location information or properties information) about controllable devices (e.g., device #1 440-1, device #2 440-2, . . . , device #N 440-N). Accordingly to this, the device control server 330 can select a device which will display a content as a response to the speech command, and control the selected device to display the content.

Additionally, the device control server 330 can control to determine a level for the displaying of a content and apply the determined level. Here, the level can be an indication indicating various aspects concerning the displaying of the content, such as items (e.g., an image, a text, or a video) included in the content, a size of the content, the location of the content on a screen, or a displaying duration of the content. In the following description, the level can be called a ‘display level’, a ‘user interface (UI) level’, a ‘displaying level’, a ‘displaying scheme’ or other terms having a technological meaning equivalent to this.

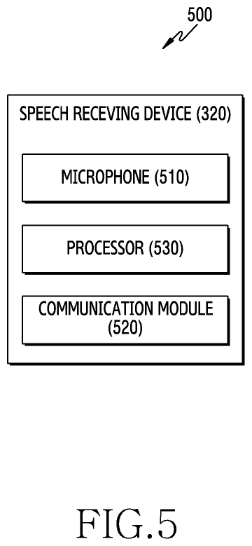

FIG. 5 is a block diagram 500 of the speech receiving device 320 receiving a speech command in accordance with various embodiments.

Referring to FIG. 5, the speech receiving device 320 can include a microphone 510 (e.g., the input device 150 of FIG. 1), a communication module 520 (e.g., the communication module 190 of FIG. 1), and a processor 530 (e.g., the processor 120 of FIG. 1). The enumerated components can be mutually operably or electrically connected.

The microphone 510 can provide an electrical signal corresponding to a vibration of a sound wave. In accordance with an embodiment, the microphone 510 can obtain a speech command of the speechmaker 310, and convert the speech command into an electrical signal. The converted electrical signal can be offered to the processor 530. In accordance with various embodiments, the microphone 510 can have two or more receiving portions installed in mutually different locations. Or, one or more microphones (not shown) different from the microphone 510 can be further included in the speech receiving device 320.

The communication module 520 can offer an interface for allowing the speech receiving device 320 to perform communication with another device (e.g., the intelligence server 220). The communication module 520 can support the establishment of a communication channel for communication between the speech receiving device 320 and another device, or the execution of communication through the established communication channel. The communication module 520 can include one or more communication processors (CP) managed independently of the processor 530 and supporting communication. The communication module 520 can support at least one of short-range communication (e.g., Bluetooth), wireless LAN, or cellular communication (e.g., long term evolution (LTE) and/or new radio (NR)). The communication module 520 can be implemented to include one or more processors or microprocessors, and/or antennas.

The processor 530 can control a general operation of the speech receiving device 320. For example, the processor 530 can process an electrical signal corresponding to a speech command provided by the microphone 510. For example, the processor 530 can perform communication by using the communication module 520. In accordance with various embodiments, the processor 530 can control the speech receiving device 320 to perform operations of various embodiments of the present disclosure described later.

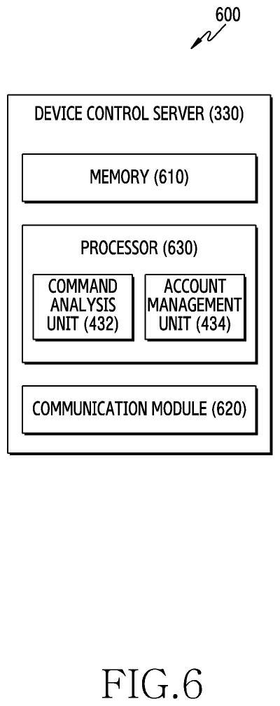

FIG. 6 is a block diagram 600 of the device control server 330 controlling to offer a content in response to a speech command in accordance with various embodiments.

Referring to FIG. 6, the device control server 330 can include a memory 610, a communication module 620, and a processor 630. The enumerated components can be mutually operably or electrically connected.

The memory 610 can store software, a microcode, or setting information, required for an operation of the device control server 330. The memory 610 can be implemented by at least one of one or more high-speed random access memories, a non-volatile memory, one or more optical storage devices, or a flash memory.

The communication module 620 can offer an interface for allowing the device control server 330 to perform communication with other devices (e.g., the intelligence server 220, the speech receiving device 320, the device #1 440-1, the device #2 440-2, . . . , or the device #N 440-N). The communication module 620 can process data in accordance with the protocol standard for accessing an Internet protocol (IP) network. The communication module 620 can be implemented to include one or more processors or microprocessors, and/or communication ports.

The processor 630 can control a general operation of the device control server 330. For example, the processor 630 can execute an application stored in the memory 610, and record information necessary for the memory 610. For example, the processor 630 can perform communication by using the communication module 620. In accordance with an embodiment, the processor 630 can include the command analysis unit 432 identifying the contents of a speech command, and/or the account management unit 434 processing a registration procedure for devices of the vicinities of the speechmaker 310 and managing information about the devices. Here, the command analysis unit 432 and the account management unit 434 can be an instruction/code at least temporarily resided in the processor 630 as an instruction set or code stored in the memory 610, or be a part of a circuitry configuring the processor 630. In accordance with various embodiments, the processor 630 can control the device control server 330 to perform operations of various embodiments of the present disclosure described later.

According to various embodiments, an electronic device (e.g., the device control server 330) can include a communication module (e.g., the communication module 620), a processor (e.g., the processor 630) operably connected to the communication module, and a memory (e.g., the memory 610) operably connected to the processor. The memory can store instructions which, when executed, cause the processor to receive, through the communication module, information relating to the contents of a speechmaker (e.g., the speechmaker 310)'s speech command acquired by an external electronic device (e.g., the speech receiving device 320), and search the vicinities of the speechmaker for one or more display devices (e.g., the display device 350) based on the location of the speechmaker determined by using measurement information concerning the speech command, and the location of the external electronic device, and determine, from the one or more display devices, a display device to display a content as a response to the speech command, and display the content through the determined display device based on at least one of the speechmaker's state, the states of the speechmaker's surroundings, and the properties of the content.

According to various embodiments, the memory (e.g., the memory 610) can store account information about a plurality of devices, and the instructions can cause the processor (e.g., the processor 630) to search the vicinities of the speechmaker (e.g., the speechmaker 310) for the one or more display devices by using location information of the plurality of devices comprised in the account information.

According to various embodiments, the instructions can cause the processor (e.g., the processor 630) to, by using the communication module (e.g., the communication module 620), receive information about a reception strength and reception angle of the speech command from the external electronic device, and estimate the location of the speechmaker (e.g., the speechmaker 310) based on the reception strength and the reception angle.

According to various embodiments, the instructions can cause the processor (e.g., the processor 630) to search for the one or more display devices by identifying one or more devices having a display function, among one or more devices having account information comprising location information which indicates being located in the same space as a space indicated by location information comprised in account information of the external electronic device.

According to various embodiments, the instructions can cause the processor (e.g., the processor 630) to determine the display device (e.g., the display device 350) which will display a content based on one of a measurement result of a wireless signal for the one or more display devices, or a measurement result concerning the speech command.

According to various embodiments, the instructions can cause the processor (e.g., the processor 630) to, by using the communication module (e.g., the communication module 620), transmit a first indication message for offering of the content to a source device concerning the content, and transmit a second indication message for displaying of the content to the display device (e.g., the display device 350).

According to various embodiments, the instructions can cause the processor (e.g., the processor 630) to determine a displaying level of the content based on at least one of the speechmaker (e.g., the speechmaker 310)'s state, the states of the speechmaker's surroundings, or the properties of the content, and transmit information about the displaying level to the display device (e.g., the display device 350) or a source device having the content.

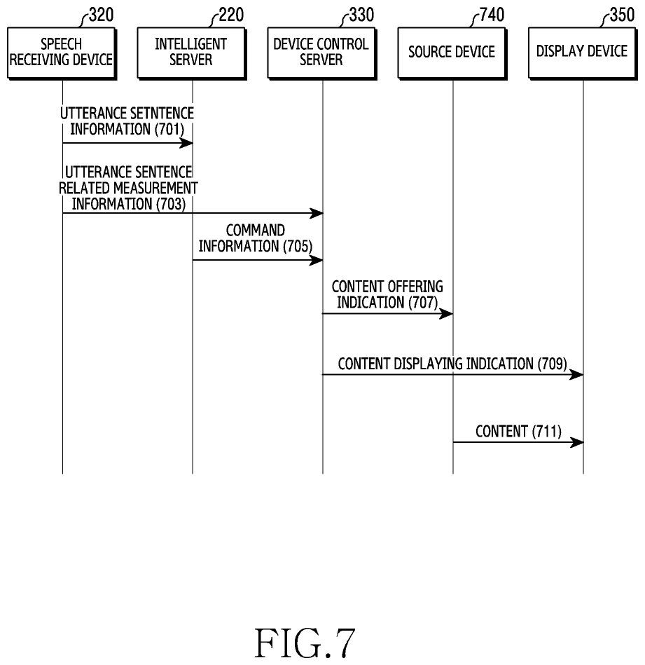

FIG. 7 is a diagram illustrating a signal exchange procedure for offering a content in response to a speech command in accordance with various embodiments.

Referring to FIG. 7, in operation 701, the speech receiving device 320 can transmit utterance sentence information to the intelligence server 220. The utterance sentence information can include data expressing a waveform of an utterance sentence received by the speech receiving device 320. In operation 703, the speech receiving device 320 can transmit utterance sentence related measurement information to the device control server 330. The utterance sentence related measurement information can include at least one of a reception strength of the utterance sentence or a reception angle of the utterance sentence.

In operation 705, the intelligence server 220 can transmit command information to the device control server 330. The command information can include information provided based on the utterance sentence information received from the speech receiving device 320. For example, the command information can include at least one of information relating to the contents of a command, information necessary for searching a content which will be offered as a response, or information relating to the form of the content.

In operation 707, the device control server 330 can transmit a content offering indication to the source device 740. The source device 740 is one of devices (e.g., the device #1 440-1, the device #2 440-2, . . . , or the device #N 440-N) registered to the device control server 330, and can be selected by the device control server 330 based on the utterance sentence related measurement value and command information. The content offering indication can include at least one of information necessary for specifying a content or information about a device (e.g., the display device 350) which will display the content.

In operation 709, the device control server 330 can transmit a content displaying indication to the display device 350. The display device 350 is one of devices (e.g., the device #1 440-1, the device #2 440-2, . . . , or the device #N 440-N) registered to the device control server 330, and can be selected based on the utterance sentence related measurement value and command information. The content displaying indication can include at least one of information (e.g., the source device 350) about a device which will offer a content, information about the speechmaker 310 and the surroundings of the speechmaker 310, or information about a scheme of displaying the content.

In operation 711, the source device 740 can transmit a content to the display device 350. The content can include a content specified by the content offering indication transmitted by the device control server 330. In an example of FIG. 7, the source device 740 and the display device 350 have been exemplified as mutually different devices, but in accordance with another embodiment, the display device 350 can perform even a role of the source device 740, thereby directly acquiring a content. In this case, operation 711 can be omitted. In accordance with a further embodiment, the device control server 330 can perform even a role of the source device 740, thereby directly acquiring a content. In this case, operation 707 can be omitted, and operation 711 can be performed by the device control server 330.

Various embodiments of the present disclosure are described below. Various operations described in the following description are described as an operation of the device control server 330. However, in accordance with another embodiment, at least some operations among the operations described later can be performed by another device. For example, it can be understood that after at least part of processing of information or data received by the device control server 330 is performed by a subject having transmitted the information or data, it is received by the device control server 330.

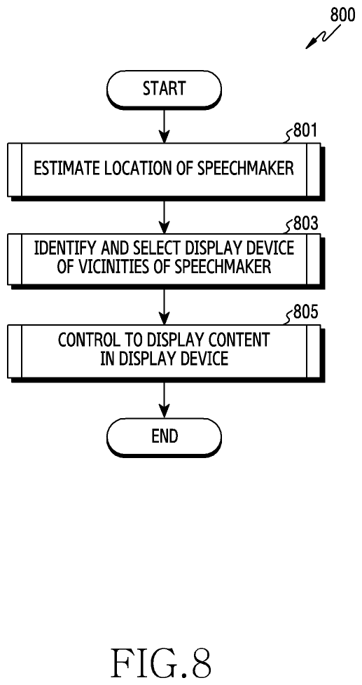

FIG. 8 is a flowchart 800 for controlling a display device to offer a content in response to a speech command in the device control server 330 according to various embodiments. An operation subject of the flowchart 800 exemplified in FIG. 8 can be understood as the device control server 330 or a component (e.g., the communication module 620 or the processor 630) of the device control server 330.

Referring to FIG. 8, in operation 801, the device control server 330 (e.g., the processor 630) can estimate the location of the speechmaker 310. By estimating the location of the speechmaker 310, the device control server 330 can determine a reference for selecting the display device 350 which will display a content as a response to a speech command. For example, the device control server 330 can estimate the location of the speechmaker 310 by using a reception strength and reception angle with respect to an utterance sentence.

In operation 803, the device control server 330 can identify and select a display device in the vicinities of the speechmaker 310. To display a content in the location where the speechmaker 310 is easy to recognize, the device control server 330 can select a display device arranged in a suitable location. For example, the device control server 330 can identify one or more display devices arranged in the vicinities of the speechmaker 310, and select a display device (e.g., the display device 350) closest to the location of the speechmaker 310 estimated in operation 801.

In operation 805, the device control server 330 can control the display device 350 to display a content. For example, the device control server 330 can offer a response corresponding to a speech command of the speechmaker 310 through the display device 350 selected in operation 803. In an embodiment, the device control server 330 can adjust a displaying scheme of a content in accordance with the state of the speechmaker 310 and the surroundings of the speechmaker 310.

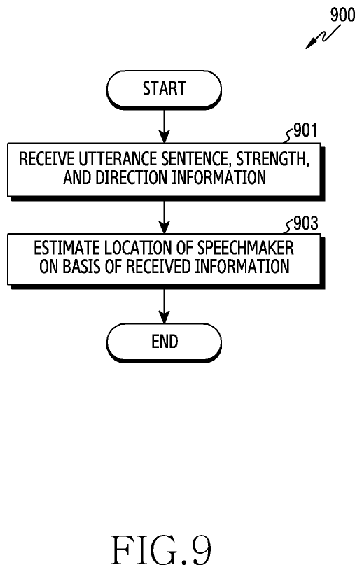

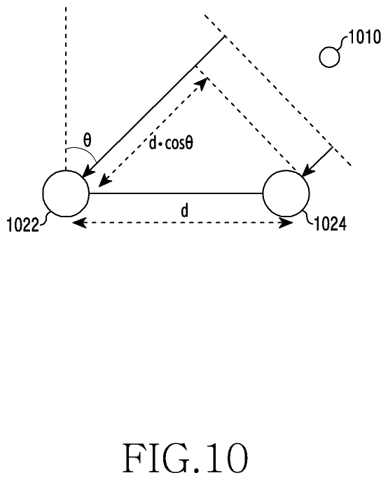

FIG. 9 is a flowchart 900 for estimating the location of a speechmaker in the device control server 330 according to various embodiments. FIG. 10 is a diagram illustrating a relative location relationship between a speechmaker and microphones according to various embodiments. The flowchart 900 exemplified in FIG. 9 is an example of operation 801 of FIG. 8, and an operation subject can be understood as the device control server 330 or a component (e.g., the communication module 620 or the processor 630) of the device control server 330.

Referring to FIG. 9, in operation 901, the device control server 330 (e.g., the processor 630) can receive information about an utterance sentence, a reception strength of the utterance sentence, and the direction of the speechmaker 310. The reception strength of the utterance sentence can be expressed by a value (e.g., a maximal value or average value) corresponding to a magnitude of an electrical signal provided by the microphone 510 of the speech receiving device 320. The direction of the speechmaker 310 can be expressed by a relative reception angle of the utterance sentence with respect to the speech receiving device 320. For example, the speech receiving device 320 can include two or more microphones or receiving portions, and the direction of the speechmaker 310 can be estimated by using a strength of the utterance sentence of the speechmaker 310, and a reception array microphone. The utterance sentence used to determine the direction of the speechmaker 310 can include at least one of a speech for activating or waking up the speech receiving device 320 or a speech for actually controlling the device in future. The relative reception angle of the utterance sentence can be measured by the principle of FIG. 10.

Referring to FIG. 10, the speech receiving device 320 can include speech obtaining points 1022 and 1024 (e.g., two or more microphones or two or more receiving portions) which are spaced a predetermined distance (e.g., d) apart. Accordingly to this, there can be a difference (e.g., d·cos θ) of distances between each of the speech obtaining points 1022 and 1024 and a speech source 1010, depending on the location of the speech source 1010 (e.g., the speechmaker 310), and there can be as much speech reception strength difference or speech arrival time difference as the difference. By using this speech reception strength difference or speech arrival time difference, a relative angle of the speech source 1010 can be estimated. In response to using the speech arrival time difference, i.e., a delay time, a relative angle (e.g., θ) can be determined using the distance (e.g., d) between the speech obtaining points 1022 and 1024, a difference of time, and a propagation speed of a speech.

In operation 903, the device control server 330 can estimate the location of the speechmaker 310 based on the received information about the reception strength of the utterance sentence and/or the direction of the speechmaker 310. The device control server 330 can estimate a distance between the speech receiving device 320 and the speechmaker 310 based on the reception strength of the utterance sentence, and can identify a relative angle of the speechmaker 310 with respect to the speech receiving device 320 based on the direction of the speechmaker 310. Because the speech receiving device 320 is identified through previously registered information, the device control server 330 can estimate the location of the speechmaker 310 from the distance between the speech obtaining points 1022 and 1024 and the relative angle.

In an embodiment described with reference to FIG. 9, the device control server 330 can receive information about the direction of the speechmaker 310. That is, after the direction of the speechmaker 310 is estimated by the speech receiving device 320, the direction of the speechmaker 310 can be offered to the device control server 330. The speech receiving device 320 can embed a codec capable of performing signal processing for a speech signal, and can determine a strength and direction of an utterance sentence. Accordingly, an operation of estimating the location (e.g., a distance and an angle) of the speechmaker 310 in accordance with an algorithm of estimating the location of the aforementioned speech source 1010 can be performed by the speech receiving device 320 or by the device control server 330 receiving the information about the strength and angle of the utterance sentence.

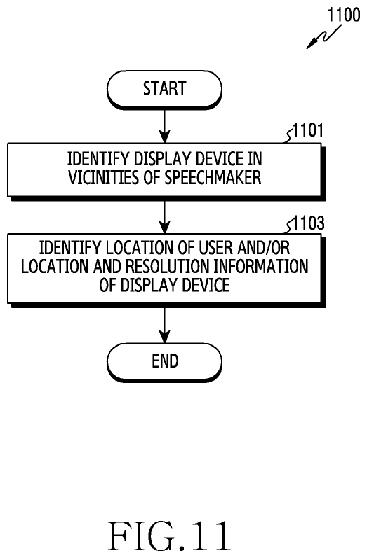

FIG. 11 is a flowchart 1100 for selecting a display device in the device control server 330 according to various embodiments. The flowchart 1100 exemplified in FIG. 11 is an example of operation 805 of FIG. 8, and an operation subject can be understood as the device control server 330 or a component (e.g., the communication module 620 or the processor 630) of the device control server 330.

Referring to FIG. 11, in operation 1101, the device control server 330 (e.g., the processor 630) can identify one or more display devices in the vicinities of the speechmaker 310. In an embodiment, the device control server 330 can store information about registered various devices. For example, the speech receiving device 320 receiving a speech command can be also registered to the device control server 330, and in this case, the device control server 330 can know information about the location of the device control server 330. Accordingly, one or more display devices arranged in an adjacent location or the same space can be identified.

In operation 1103, the device control server 330 can identify the location of the speechmaker 310, and/or location and resolution information of the display device. For example, the device control server 330 can select a display device (e.g., the display device 350) closest to the location of the speechmaker 310 among the one or more display devices arranged in the vicinities of the speechmaker 310. For this, the device control server 330 can identify the location of the speechmaker 310, and identify the closest display device. Further, the device control server 330 can identify the properties (e.g., a resolution) of the selected display device.

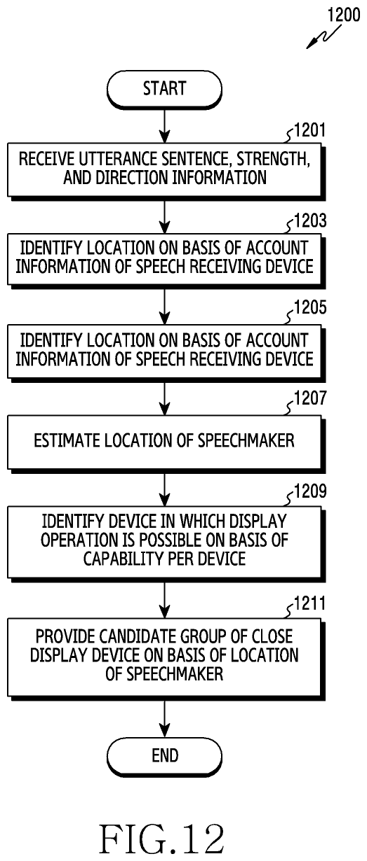

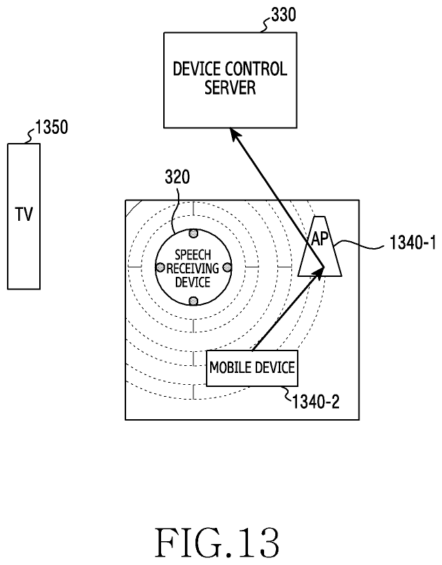

FIG. 12 is a flowchart 1200 for identifying display devices of the vicinities of the speechmaker 310 in the device control server 330 according to various embodiments. FIG. 13 is a diagram illustrating an example of a peripheral device of a speech receiving device according to various embodiments. The flowchart 1200 exemplified in FIG. 12 is an example of operation 803 of FIG. 8, and an operation subject can be understood as the device control server 330 or a component (e.g., the communication module 620 or the processor 630) of the device control server 330.

Referring to FIG. 12, in operation 1201, the device control server 330 (e.g., the processor 630) can receive information about an utterance sentence, a reception strength of the utterance sentence, and the direction of the speechmaker 310. In an embodiment, the device control server 330 can receive identification information of the speech receiving device 320, an utterance sentence, a strength of the utterance sentence, and/or direction information, which are received from the speech receiving device 320. The reception strength of the utterance sentence can be expressed by a value (e.g., a maximal value or average value) corresponding to a magnitude of an electrical signal provided by the microphone 510 of the speech receiving device 320. The direction of the speechmaker 310 can be expressed by a relative reception angle of the utterance sentence with respect to the speech receiving device 320.

In operation 1203, the device control server 330 can identify the location of the speech receiving device 320 based on account information of the speech receiving device 320. To grasp the location of the speechmaker 310, the estimating of the location of the speech receiving device 320 can be needed. For example, by using the identification information of the speech receiving device 320, the device control server 330 can acquire location information of the speech receiving device 320 recorded as the account information. The account information can include information about a device registered to the device control server 330, and include a location, a kind, a capability, a state, and/or a software version. For example, the location can be recorded as information about a location such as a ‘living room’ or a ‘bedroom’, in course of a process of registering the speech receiving device 320 to the device control server 330. The location information of the speech receiving device 320 can be registered through a terminal device of the speechmaker 310. Or, when the speech receiving device 320 has a location based service (LBS) system such as a global positioning system (GPS), location information measured by the speech receiving device 320 for itself can be offered in course of the registration process or at a time point of offering information (e.g., identification information, an utterance sentence, a strength of the utterance sentence, or direction information).

In operation 1205, the device control server 330 can identify location information of peripheral devices based on the location of the speech receiving device 320. To select a device proximal to the speechmaker 310 in an operation described later, the device control server 330 can identify the location information. The device control server 330 can identify peripheral devices located in the same space as the speech receiving device 320 or located at a specified distance, among a plurality of devices registered to the device control server 330. For example, for a fixed device whose movement after installation is not active such as a TV or a washing machine, the device control server 330 can use the stored account information. For another example, for a device having portability, the device control server 330 can identify location information through an indoor location/indoor localization technique that uses an LBS system. For further example, the device control server 330 can use a sound signal as in FIG. 13.

Referring to FIG. 13, the device control server 330 can control the speech receiving device 320 to output a predefined sound signal. Accordingly to this, a mobile device 1340-2 located in the same space receives the sound signal, but a TV 1350 located outside the space may fail to receive the sound signal. Accordingly to this, the mobile device 1340-2 can transmit a message of notifying the reception of the sound signal to the device control server 330 via an AP 1340-1 or via another communication path (e.g., a cellular communication system). Owing to this, the device control server 330 can determine that the mobile device 1340-2 is a peripheral device of the speech receiving device 320, but the TV 1350 is not the peripheral device.

In operation 1207, the device control server 330 can estimate the location of the speechmaker 310. For example, the device control server 330 can estimate the location of the speechmaker 310, based on the information about the reception strength of the utterance sentence and/or the direction of the speechmaker 310, received in operation 1201. In accordance with another embodiment, operation 1209 can be first performed prior to identifying the peripheral device of the speech receiving device 320.

In operation 1209, the device control server 330 can identify a peripheral device in which a displaying operation is possible based on capability information per device. For example, the capability information per device can be part of account information registered to the device control server 330. The device control server 330 can identify the capability information in the account information of the peripheral devices, and identify one or more devices defined as being possible to perform a displaying function by the capability information.

In operation 1211, the device control server 330 can provide a candidate group of close display devices based on the location of the speechmaker 310. For example, the device control server 330 can include, in the candidate group of the display devices, one or more display devices having a displaying function among the peripheral devices of the speech receiving device 320. Although not illustrated in FIG. 12, one of the one or more display devices included in the candidate group can be finally selected as a display device which will display a content.

In an embodiment described with reference to FIG. 12, the account information can be used to identify the location information of the device. In accordance with another embodiment, in place of the account information or along with the account information, open connectivity foundation (OCF) based resource model information can be used. The OCF based resource model information is information exchanged at communication between Internet of things (IoT) devices, and the device control server 330 can hold synchronized resource model information. Accordingly, the device control server 330 can identify the location of the devices by using the resource model information of <Table 1> below.

TABLE 1

| Field | Type | Description |
|---|---|---|
| deviceHandle | String | The local unique ID for device |
| deviceType | String | DeviceTypeUri |
| deiceName | String | Device name |
| resourceUris | String | All resource URIs of device |
| locationId | String | Location Id of device |
| locationName | String | Location name of device |
| owner | String | Device permission of user |
| firmware version | String | Device firmware version |
| metadata | JSON | UIMetadata of devic |

Similarly, even the capability information of the device can be identified from the resource model information of <Table 2> below.

TABLE 2

| Device | Device | | |
|---|---|---|---|
| Name | Type | Required Resource name | Required |
| Television | oic.d.tv | Binary Switch | oic.r.switch, binary |
| | | Audio Controls | oic.r.audio |
| | | Media Source List | oic.r.media, input |

In the aforementioned various embodiments, to display a content in a display device closest to the speechmaker 310, the device control server 330 can estimate the location of the speechmaker 310 and the location of the display device. Because the location of the speechmaker 310 is estimated based on a strength and direction of an utterance sentence, when an accurate location of the speech receiving device 320 is known, the location of the speechmaker 310 can be estimated.

In accordance with another embodiment, when a device possible to photograph exists in a space in which the speechmaker 310 is located, the device control server 330 can acquire an image or video photographed using the device, and estimate the location of the speechmaker 310 by using the image or video.

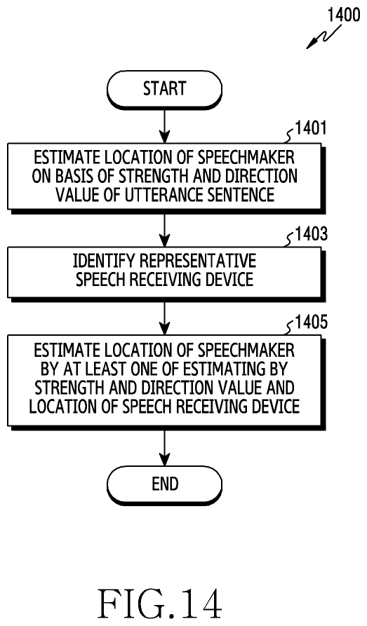

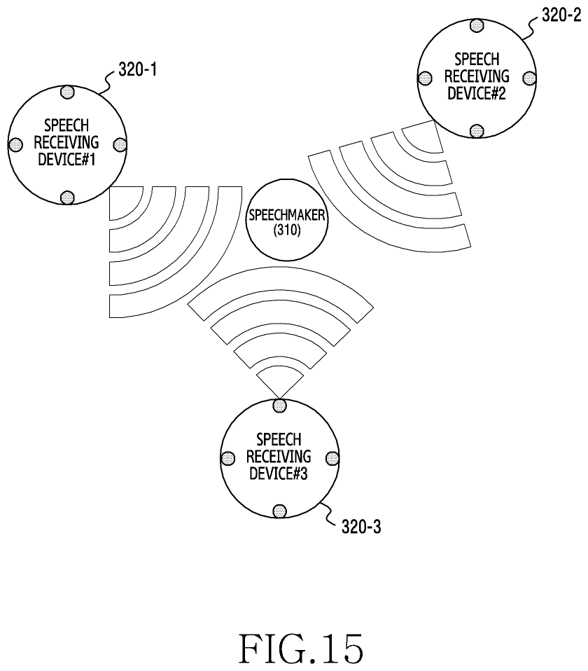

In accordance with a further embodiment, when a plurality of speech receiving devices exists, the location of the speechmaker 310 can be estimated using a representative speech receiving device. An example of estimating the location of the speechmaker 310 by using the representative speech receiving device is described below with reference to FIG. 14 and FIG. 15.

FIG. 14 is a flowchart 1400 for estimating the location of the speechmaker 310 in the device control server 330 according to various embodiments. FIG. 15 is a diagram illustrating an example in which a plurality of speech receiving devices are arranged according to various embodiments. The flowchart 1400 exemplified in FIG. 14 is an example of operation 801 of FIG. 8, and an operation subject can be understood as the device control server 330 or a component (e.g., the communication module 620 or the processor 630) of the device control server 330.

Referring to FIG. 14, in operation 1401, the device control server 330 (e.g., the processor 630) can estimate the location of a speechmaker based on a strength and direction value of an utterance sentence. A distance from the speech receiving device 320 can be estimated by the strength of the utterance sentence, and a relative angle with respect to the speech receiving device 320 can be estimated based on the direction value.

In operation 1403, the device control server 330 can identify a representative speech receiving device. For example, when a speech receiving device #1 320-1, a speech receiving device #2 320-2 or a speech receiving device #3 320-3 exist as in FIG. 14, the utterance sentence can be received all in each of the speech receiving device #1 320-1, the speech receiving device #2 320-2 or the speech receiving device #3 320-3. At this time, the reception strength of the utterance sentence can be different, and which speech receiving device the speechmaker 310 is located closest to among the speech receiving device #1 320-1, the speech receiving device #2 320-2 or the speech receiving device #3 320-3 can be determined depending on reception strength and/or reception time information of the utterance sentence. After the device control server 330 receives the information about the utterance sentence reception strength and/or reception time from each of the speech receiving device #1 320-1, the speech receiving device #2 320-2 or the speech receiving device #3 320-3, the device control server 330 can select one speech receiving device having the largest reception strength and/or the shortest reception time.

In operation 1405, the device control server 330 can estimate the location of the speechmaker by at least one of estimating by the strength and direction value and the location of the representative speech receiving device. The device control server 330 can determine the location of the speechmaker 310 on the basis of any one of the location of the speechmaker estimated in operation 1401 and the location of the representative speech receiving device identified in operation 1403 or a combination of the both.

In response to the location of the speechmaker 310 being estimated, thereafter, a display device of the vicinities of the speechmaker 310 can be searched. Various operations for searching for the display device are given as follows.

In response to indoor location/indoor localization being possible in that the display device has a communication capability, the device control server 330 can acquire location information about the display device. For example, in response to a TV being possible to communicate with an AP by using a wireless LAN technology operating at 2.4/5 GHz, a relative location of the TV can be estimated with reference to the AP. In detail, a distance can be identified through a flight of time (FOT) based fine time measurement (FTM) protocol, and an angle can be identified through an angle of arrival (AOA) or angle of departure (AOD) of a signal. Or, in response to using 60 GHz, a precise distance and a precise angle can be identified based on beamforming.

In response to not being able to concretely identify the location of a target display device, the device control server 330 can limit the target display device based on the location of the speech receiving device 320. In an embodiment, the device control server 330 can limit the target display device to a device existing near the speech receiving device 320. For example, in response to it being identified that the speech receiving device 320 is in a ‘living room’, a display device existing in the ‘living room’ can be selected. Or, a device belonging to a local network such as the speech receiving device 320 can be selected as well. Or, it can be a device capable of receiving a sound outputted from the speech receiving device 320 based on a sound. Or, when a plurality of speech receiving devices (e.g., the speech receiving device #1 320-1, the speech receiving device #2 320-2 or the speech receiving device #3 320-3) exist, and a representative device corresponding to each speech receiving device has been defined, a device having a display function can be selected among representative devices of one or more speech receiving devices receiving an utterance sentence.

In response to comparatively clearly identifying the location of the speechmaker 310 and the location of the display device, one display device being closest can be selected as a device which will display a content. In response to the location not being identified clearly, a plurality of display devices can be selected. In this case, all or some of the plurality of display devices can display a content.

In response to being capable of estimating a progress direction of an utterance sentence of the speechmaker 310, a display device located in the progress direction of the utterance sentence can be selected. In response to there being a separate module capable of estimating a progress direction of uttering, the progress direction of the utterance sentence can be estimated. For example, when the speech receiving device 320 included in a plurality of array microphones exists, the device control server 330 can concurrently identify the speechmaker 310 and the progress direction of the utterance sentence, and select a display device of the direction. For another example, in response to there being a photographing device located near the speechmaker 310, the device control server 330 can analyze a movement direction of the speechmaker 310, and select a display device located in the movement direction.

In response to the plurality of speech receiving devices (e.g., the speech receiving device #1 320-1, the speech receiving device #2 320-2 or the speech receiving device #3 320-3) being arranged as in FIG. 15, devices of the vicinities of the speechmaker 310 can be classified with reference to each speech receiving device. Accordingly to this, in response to the representative speech receiving device being selected, candidate devices to determine a device which will display a content can be limited according to the representative speech receiving device.

Some of the speech receiving device #1 320-1, the speech receiving device #2 320-2 or the speech receiving device #3 320-3 shown in FIG. 15 can be installed in the display device. In this case, because not only a microphone but also a speaker is available, the speech receiving device #1 320-1, the speech receiving device #2 320-2 or the speech receiving device #3 320-3 exchanges a sound signal whereby the location of a display device which will display a content can be divided and determined on a per-region basis according to the location of the speechmaker 310.

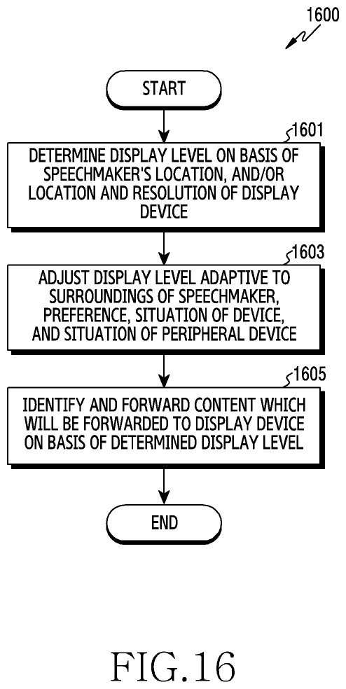

FIG. 16 is a flowchart 1600 for forwarding a content corresponding to a speech command in the device control server 330 according to various embodiments. The flowchart 1600 exemplified in FIG. 16 is an example of operation 805 of FIG. 8, and an operation subject can be understood as the device control server 330 or a component (e.g., the communication module 620 or the processor 630) of the device control server 330.

Referring to FIG. 16, in operation 1601, the device control server 330 (e.g., the processor 630) can determine a display level based on the location of a speechmaker and/or the location and resolution of a display device. In an embodiment, the device control server 330 can determine a displaying scheme of a content according to a feature of the display device. For example, the feature of the display device can include a hardware feature such as a resolution of a screen, the number of outputtable colors, or a brightness.

In operation 1603, in an embodiment, the device control server 330 can adjust the display level suitably to the states of the surroundings of the speechmaker 310 and a preference, a situation of a device, and/or a situation of a peripheral device. For example, the device control server 330 can adjust a displaying scheme determined according to a capability of the display device, based on the state of the speechmaker 310 or the states of the surroundings.

In operation 1605, the device control server 330 can identify a content which will be forwarded to the display device based on the determined display level, and forward the identified content. For example, the device control server 330 can provide a content according to the display level, and transmit the provided content to the display device. In accordance with another embodiment, the device control server 330 can notify the determined display level to another device having a content, and control the another device to offer the content to the display device. In accordance with a further embodiment, the device control server 330 can notify the determined display level to the display device, and the content can be changed, processed or provided according to the display level determined by the display device.

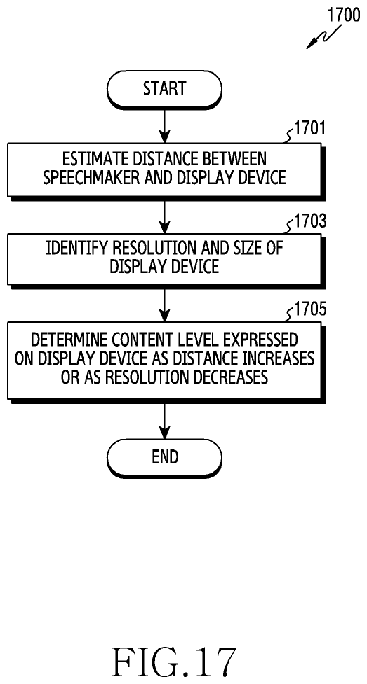

FIG. 17 is a flowchart 1700 for determining a level of a content in the device control server 330 according to various embodiments. The flowchart 1700 exemplified in FIG. 17 is an example of operation 805 of FIG. 8, and an operation subject can be understood as the device control server 330 or a component (e.g., the communication module 620 or the processor 630) of the device control server 330.

Referring to FIG. 17, in operation 1701, the device control server 330 (e.g., the processor 630) can estimate a distance between the speechmaker 310 and a display device. For example, the device control server 330 can estimate the distance between the speechmaker 310 and the display device based on at least one of a distance of a display device which is identified using location information and account information of the speechmaker 310 estimated in order to select the display device.

In operation 1703, the device control server 330 can identify a resolution and size of the display device. By using the account information, the device control server 330 can identify an expressible resolution and screen size of the display device.

In operation 1705, the device control server 330 can determine a level of a content expressed in the display device as the distance between the display device and the speechmaker 310 is increased or as the resolution is decreased. In response to the location of the speechmaker 310 and the location of the display device being determined, the device control server 330 can adjust a size of a content which will be displayed in the display device, in proportion to the distance between the speechmaker 310 and the display device, based on the determined locations. For example, in response to the resolution being low, the device control server 330 can increase the size of the content. For example, when a changeable level of a content corresponding to a speech command is a total of five steps, the device control server 330 can determine a display level according to a distance. The resolution of the display device can be defined in the form of <Table 3> below. For another example, even a rule defined using a separate equation, etc. is usable.

TABLE 3

| | SD | HD | FHD | QHD | UHD |
|---|---|---|---|---|---|
| Distance 0-3 (m) | 5 | 4 | 3 | 2 | 1 |
| Distance 3-5 (m) | 5 | 5 | 4 | 3 | 2 |
| Distance 5-8 (m) | 5 | 5 | 5 | 4 | 3 |
| Distance 8-11 (m) | 5 | 5 | 5 | 5 | 4 |
| Distance 11- (m) | 5 | 5 | 5 | 5 | 5 |

<Table 3> defines a size of a resolution but, additionally, a rule related to a screen size or a rate of a resolution to screen size and a distance can be defined.

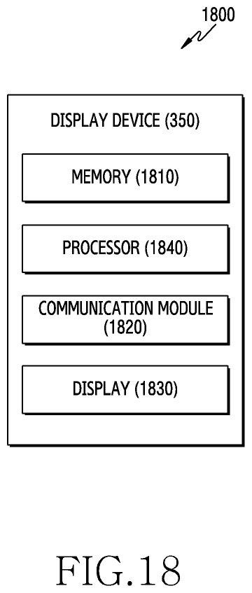

FIG. 18 is a block diagram 1800 of a display device displaying a content in accordance with various embodiments.

Referring to FIG. 18, the display device 350 can include a memory 1810 (e.g., the memory 130 of FIG. 1), a communication module 1820 (e.g., the communication module 190 of FIG. 1), a display 1830 (e.g., the display device 160 of FIG. 1), and/or a processor 1840 (e.g., the processor 120 of FIG. 1). The enumerated components can be mutually operably or electrically connected.

The memory 1810 can store software, a microcode, and/or setting information, which are necessary for an operation of the display device 350. The memory 1810 can be implemented by at least one of one or more high-speed random access memories, a non-volatile memory, one or more optical storage devices, or a flash memory.

The communication module 1820 can offer an interface for allowing the display device 350 to perform communication with another device (e.g., the device control server 330). The communication module 1820 can process data according to a protocol standard for accessing an IP network. The communication module 1820 can be implemented to include one or more processors (or microprocessors) and/or communication ports.

The display 1830 can be a component for visually expressing an image, a graphic and/or a text. For example, the display 1830 can include at least one of a liquid crystal display (LCD), a light emitting diode (LED), a light emitting polymer display (LPD), an organic light emitting diode (OLED), an active matrix organic light emitting diode (AMOLED), or a flexible LED (FLED).

The processor 1840 can control a general operation of the display device 350. For example, the processor 1840 can execute an application stored in the memory 1810, and record information necessary for the memory 1810. For example, the processor 1840 can perform communication by using the communication module 1820. For example, the processor 1840 can display a content by using the display 1830. In accordance with various embodiments, the processor 1840 can control the display device 350 to perform operations of various embodiments of the present disclosure described later.

According to various embodiments, an electronic device (e.g., the display device 350) can include a display (e.g., the display 1830), a communication module (e.g., the communication module 1820), a processor (e.g., the processor 1840) operably connected to the display and the communication module, and a memory (e.g., the memory 1810) operably connected to the processor. The memory can store instructions which, when executed, cause the processor to receive an indication message for displaying of a content and the content as a response to a speechmaker (e.g., the speechmaker 310)'s speech command acquired by an external electronic device (e.g., the speech receiving device 320), and display the content based on at least one of the speechmaker's state, the states of the speechmaker's surroundings, and the properties of the content, through the display, based on the indication message.

According to various embodiments, the instructions can cause the processor (e.g., the processor 1840) to determine a size of the content according to a distance between the speechmaker (e.g., the speechmaker 310) and the display device (e.g., the display device 350).

According to various embodiments, the instructions can cause the processor (e.g., the processor 1840) to determine a rate of items constructing the content according to a distance between the speechmaker (e.g., the speechmaker 310) and the display device (e.g., the display device 350).

According to various embodiments, the instructions can cause the processor (e.g., the processor 1840) to determine the size of the content according to a movement speed of the speechmaker (e.g., the speechmaker 310).

According to various embodiments, the instructions can cause the processor (e.g., the processor 1840) to deform the content according to the location of the speechmaker (e.g., the speechmaker 310) with respect to the display device (e.g., the display device 350).

According to various embodiments, the instructions can cause the processor (e.g., the processor 1840) to change a displaying level of the content, based on a feedback of the speechmaker (e.g., the speechmaker 310) sensed after the content is displayed.

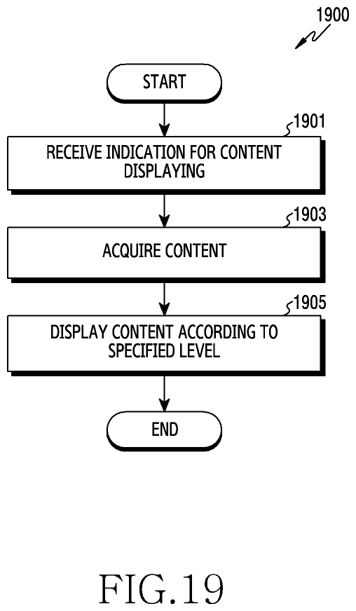

FIG. 19 is a flowchart 1900 for displaying a content in the display device 350 according to various embodiments. An operation subject of the flowchart 1900 exemplified in FIG. 19 can be understood as the display device 350 or a component (e.g., the communication module 1820, the display 1830, or the processor 1840) of the display device 350.

Referring to FIG. 19, in operation 1901, the display device 350 (e.g., the processor 1840) can receive an indication for displaying of a content. The display device 350 can receive the indication for displaying of the content from the device control server 330. The indication for the displaying of the content can include at least one of information about the content, information about a displaying level of the content, or information for acquiring of the content.

In operation 1903, the display device 350 can acquire a content. The display device 350 can acquire the required content through the device control server 330, another device, or web search.

In operation 1905, the display device 350 can display the content according to a specified level. The display device 350 can display the configured content according to the specified level, based on the information received from the device control server 330. For example, the display device 350 can display the configured content according to a specified level, or directly configure the content according to the level and then display.

As described above, a content can be displayed in the display device 350 according to the control of the device control server 330. At this time, the content displayed in the display device 350 can be configured depending on a displaying level. The displaying level can be determined based on at least one of the state of the speechmaker 310, the states of the surroundings, or the properties of the content. For example, the state of the speechmaker 310 can include a distance between the speechmaker 310 and the display device 350, an age of the speechmaker 310, the eyesight of the speechmaker 310, the movement or non-movement of the speechmaker 310, a movement speed of the speechmaker 310, or ages of the speechmaker 310. For example, the states of the surroundings can include an illumination, a time zone, whether it is a public place, or the existence or non-existence of another person. For example, the properties of the content can include whether it is private information, or whether it requires security. Below, the present disclosure describes concrete examples of the displaying level of the content with reference to the drawings.

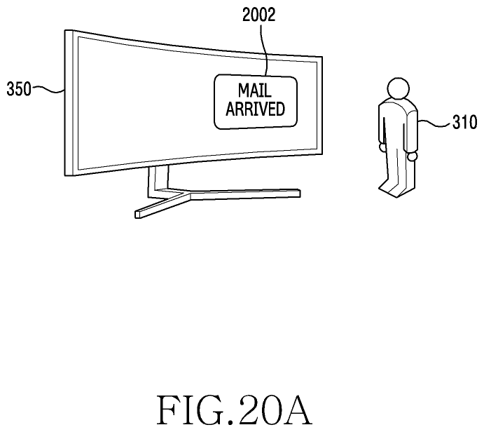

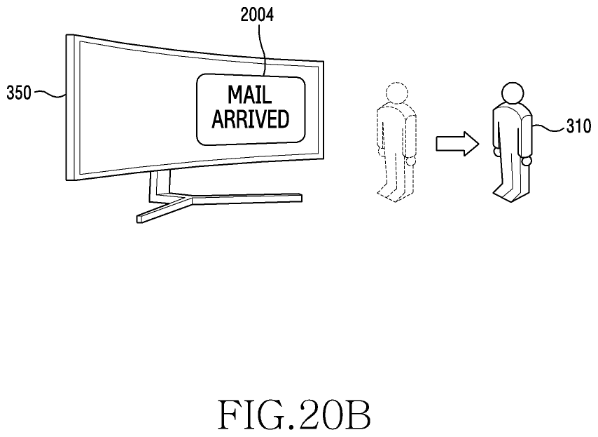

FIG. 20A and FIG. 20B are diagrams illustrating an example of a size change of a content displayed in a display device according to various embodiments. FIG. 20A and FIG. 20B exemplify a situation in which a size of a content is changed depending on a distance between the speechmaker 310 and the display device 350. Referring to FIG. 20A and FIG. 20B, the display device 350 can display a content notifying that an e-mail is received. In response to the distance between the display device 350 and the speechmaker 310 being closer than a specified distance as in FIG. 20A, a content 2002 of a small size can be displayed. However, in response to the distance between the display device 350 and the speechmaker 310 being farther than the specified distance as in FIG. 20B, a content 2004 of a big size can be displayed. Here, the specified distance can be defined by various references. For example, the specified distance can be defined according to a screen size of the display device 350 and/or the contents of a displayed content (e.g., the content 2002 or the content 2004). For example, the specified distance can be defined as dozens of centimeters or a few meters.

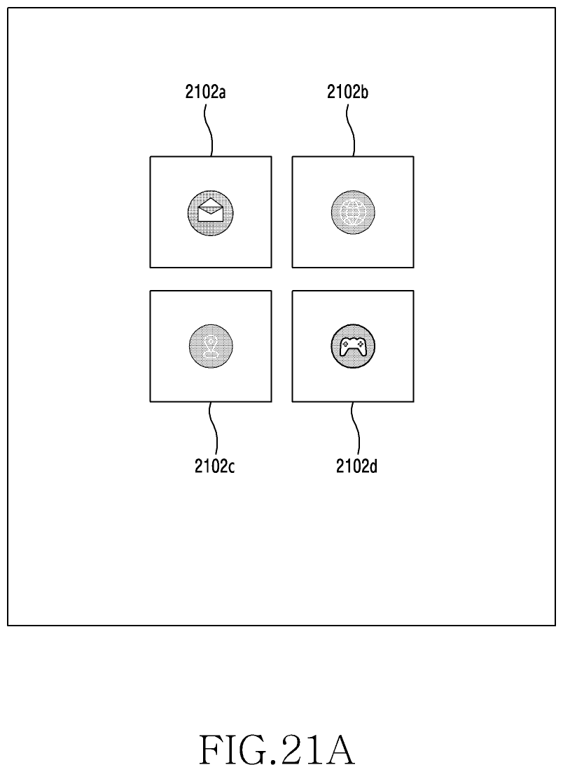

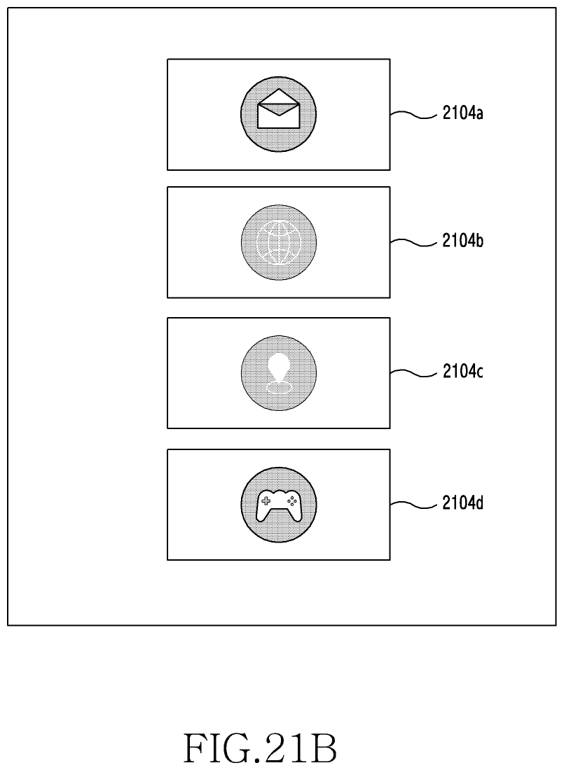

FIG. 21A and FIG. 21B are diagrams illustrating another example of a size change of a content displayed in a display device according to various embodiments. FIG. 21A and FIG. 21B exemplify a situation in which a size and layout of the content are changed depending on a distance between the speechmaker 310 and the display device 350. Referring to FIG. 21A and FIG. 21B, a set of a plurality of icons can be displayed. For example, in response to the distance between the display device 350 and the speechmaker 310 being closer than a specified distance, icons 2102a, 2102b, 2102c, and 2102d of a relatively small size arranged in a 2×2 array can be displayed as in FIG. 21A. For another example, in response to the distance between the display device 350 and the speechmaker 310 being farther than the specified distance, icons 2104a, 2104b, 2104c, and 2104d of a relatively big size arranged in a 4×1 array can be displayed as in FIG. 21B.

As described above, by changing the size of the content depending on the distance between the display device 350 and the speechmaker 310, the speechmaker 310 can easily recognize and understand the content even at a distant distance. Similarly, the size of the content can be adaptively changed based on another reference, for example, an age or eyesight of the speechmaker 310, not the distance between the display device 350 and the speechmaker 310. Even when it is a display of the same distance and the same size, when information such as the age and/or eyesight of the speechmaker 310 is identified based on account information of a user, the device control server 330 can apply a displaying level of displaying larger than a defined size for the sake of the speechmaker 310 who is equal to or is greater than a specified age or is equal to or is less than a specified eyesight.

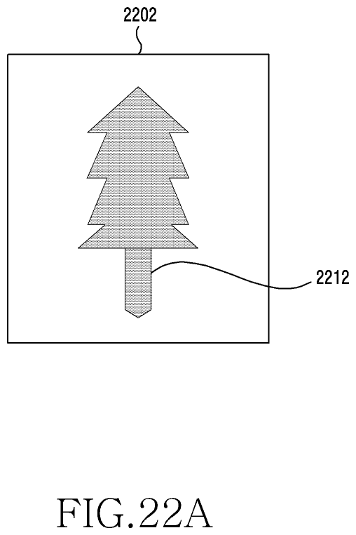

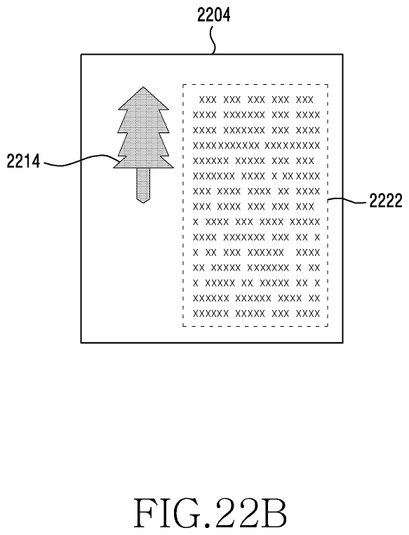

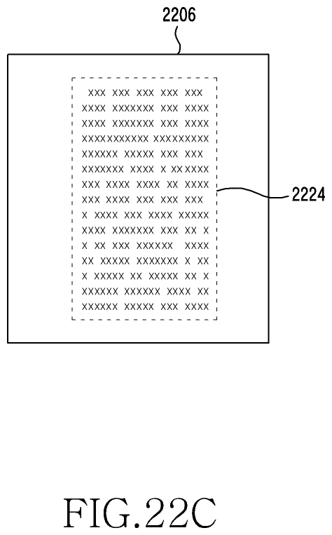

FIG. 22A, FIG. 22B and FIG. 22C are diagrams illustrating examples of various expression schemes of a content displayed in a display device according to various embodiments. FIG. 22A, FIG. 22B and FIG. 22C exemplify a situation in which a rate of items (e.g., an image and a text) configuring a content is changed depending on the state (e.g., a distance, an age and/or the eyesight) of the speechmaker 310. In response to being specified to a first level, a content 2202 configured only with an image 2212 can be displayed as in FIG. 22A. In response to being specified to a second level, a content 2204 configured with a small image 2214 and a text 2222 can be displayed as in FIG. 22B. In response to being specified to a third level, a content 2206 configured only with a text 2224 can be displayed as in FIG. 22C.

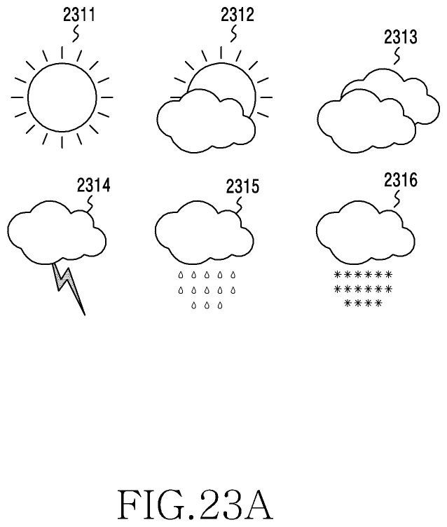

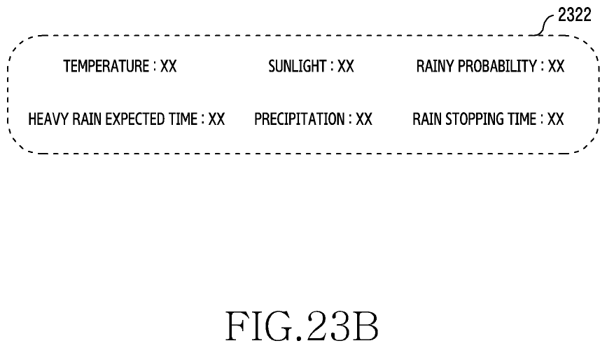

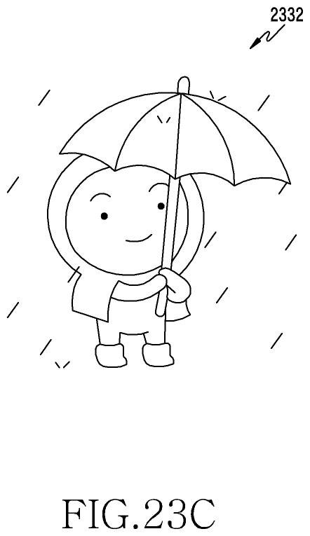

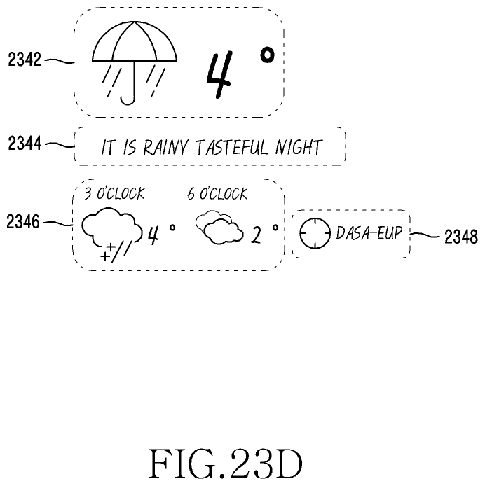

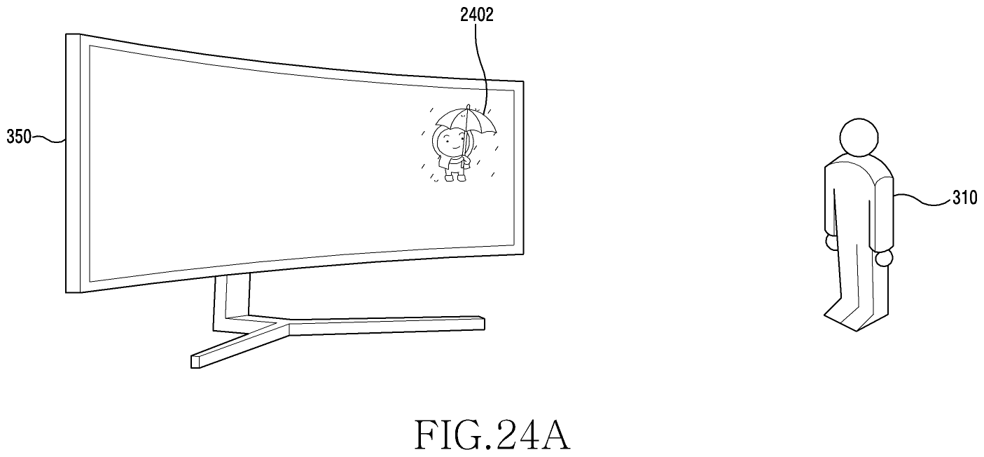

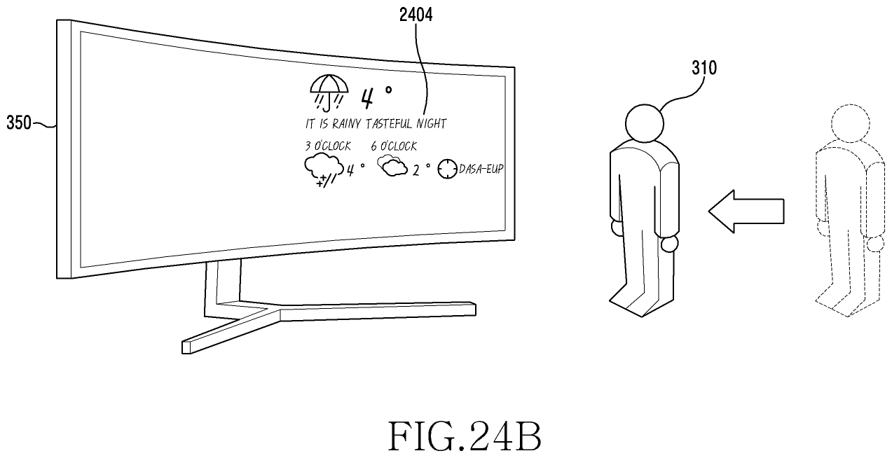

FIG. 23A, FIG. 23B, FIG. 23C and FIG. 23D are diagrams illustrating other examples of various expression schemes of a content displayed in a display device according to various embodiments. FIG. 23A, FIG. 23B, FIG. 23C and FIG. 24D are examples of a content including weather information, and exemplify a situation in which items (e.g., an image and a text) configuring the content and a level of information are changed depending on the state (e.g., a distance, an age and/or the eyesight) of the speechmaker 310. In response to being specified to a first level, a content configured with graphic icons 2311 to 2316 indicating weather can be displayed as in FIG. 23A. In response to being specified to a second level, a content expressing information indicating weather by texts 2322 can be displayed as in FIG. 23B. In response to being specified to a third level, a content using a character image 2332 can be displayed as in FIG. 23C. In response to being specified to a fourth level, a content including an item 2342 indicating rainfall or non-rainfall and a temperature, a phrase 2344 depicting weather, an item 2346 indicating weather per hour zone, and/or an item 2348 indicating a location can be displayed as in FIG. 23D.

FIG. 24A and FIG. 24B are diagrams illustrating an example of a form change of a content displayed in a display device according to various embodiments. FIG. 24A and FIG. 24B exemplify a situation in which a form of a content is changed depending on a distance between the speechmaker 310 and the display device 350. Referring to FIG. 24A and FIG. 24B, the display device 350 can display a content notifying weather. In response to the distance between the speechmaker 310 and the display device 350 being farther than a specified distance as in FIG. 24A, a content 2402 including a character graphic relatively easy to be understood can be displayed in the display device 350. However, in response to the distance between the speechmaker 310 and the display device 350 being closer than the specified distance as in FIG. 24B, a content 2404 including more detailed information combining a text and a graphic can be displayed in the display device 350.

As described above, the construction of the content can be changed depending on the state of the speechmaker 310. The mapping of the state and the construction of the content can be different according to various embodiments. For example, as a distance becomes distant, a rate of a graphic or image can be increased. For example, as an age of the speechmaker 310 is small, a rate of a graphic or image can be increased. For example, as the eyesight of the speechmaker 310 is bad, the rate of the graphic or image can be increased.

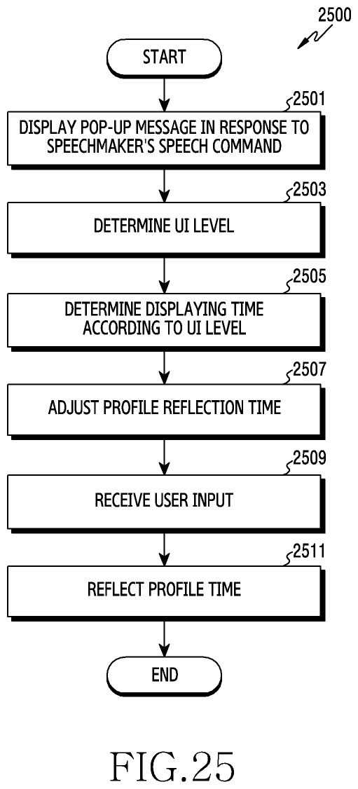

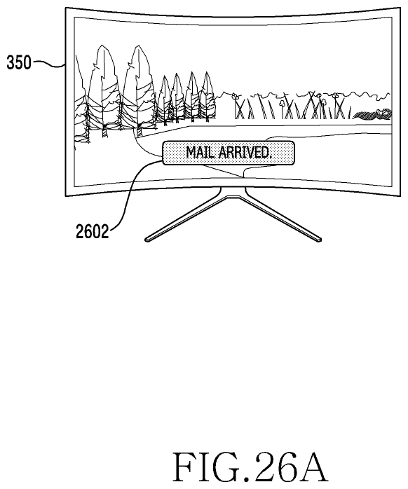

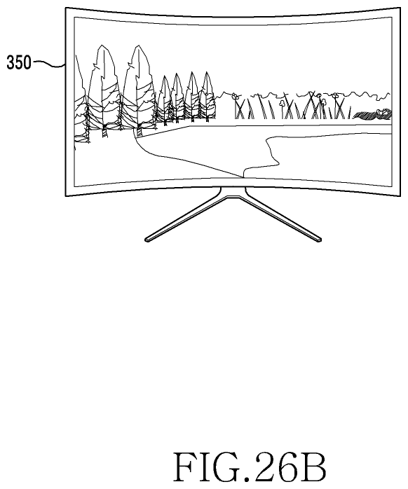

FIG. 25 is a flowchart 2500 for displaying a content in consideration of time in the display device 350 according to various embodiments. FIG. 26A and FIG. 26B are diagrams illustrating an example of a change dependent on a flow of time, of a content displayed in the display device 350 according to various embodiments. An operation subject of the flowchart 2500 exemplified in FIG. can be understood as the display device 350 or a component (e.g., the communication module 1820, the display 1830, or the processor 1840) of the display device 350.

Referring to FIG. 25, in operation 2501, the display device 350 (e.g., the processor 1840) can display a pop-up message based on a speech command of the speechmaker 310. The display device 350 can display a content in the form of a pop-up message according to an indication of the device control server 330. For example, as in FIG. 26A, the display device 350 can display a pop-up message 2602 notifying the reception of a mail on the display 1830.

In operation 2503, the display device 350 can determine a UI level. The UI level can be indicated by the device control server 330. In operation 2505, the display device 350 can determine a displaying duration of a content according to the UI level. In operation 2507, the display device 350 can adjust a profile reflection time. Here, a profile can mean a set of control information about displaying of a content. The profile can include the displaying duration.

In operation 2509, the display device 350 can receive a user input. Here, the user may be, or not be, the same person as the speechmaker 310. The user input is a feedback changing a displaying scheme of a content, and can be recognized by the display device 350, or be recognized by another device and thereafter be received by the display device 350 through the device control server 330. For example, the user input can include at least one of a speech command, a gesture, or a touch input, of the contents of requesting display interruption. In operation 2511, the display device 350 can reflect a profile time. The display device 350 can modify displaying duration information within a profile according to the user input, and apply the modified duration information. Accordingly to this, as in FIG. 26B, the pop-up message 2602 displayed in the display device 350 in FIG. 26A can be eliminated.

In an embodiment described with reference to FIG. 25, after the display device 350 displays the pop-up message, the display device 350 can determine the UI level and the displaying duration. Unlike this, in accordance with another embodiment, the displaying operation in operation 2501 can be performed after the UI level and the displaying duration are determined. For example, after the display device 350 determines the UI level and the displaying duration, the display device 350 can display the pop-up message according to the determined UI level and displaying duration.

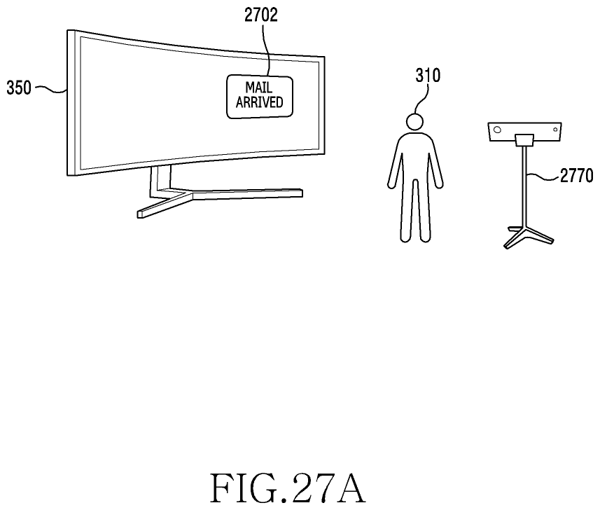

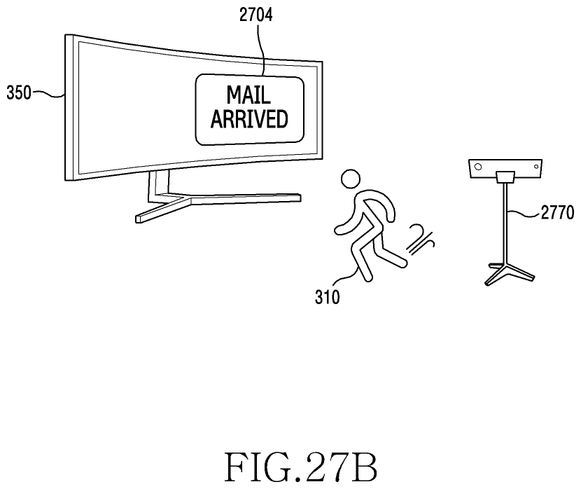

FIG. 27A and FIG. 27B are diagrams illustrating a further example of a size change of a content displayed in the display device 350 according to various embodiments. FIG. 27A and FIG. 27B exemplify a situation in which a size of a content is changed depending on the movement of the speechmaker 310. Referring to FIG. 27A and FIG. 27B, the display device 350 can display a content notifying that an e-mail is received. As in FIG. 27A, in response to the speechmaker 310 not moving, a content 2702 of a specified size or less can be displayed. However, as in FIG. 27B, in response to the speechmaker 310 moving, a content 2704 of a specified size or more can be displayed. The movement or non-movement of the speechmaker 310 can be recognized by a photographing device 2770 located near the speechmaker 310. At this time, a concrete size of the content 2704 can be adjusted according to a movement speed of the speechmaker 310. For example, as the movement speed is fast, the size of a content can be more increased.

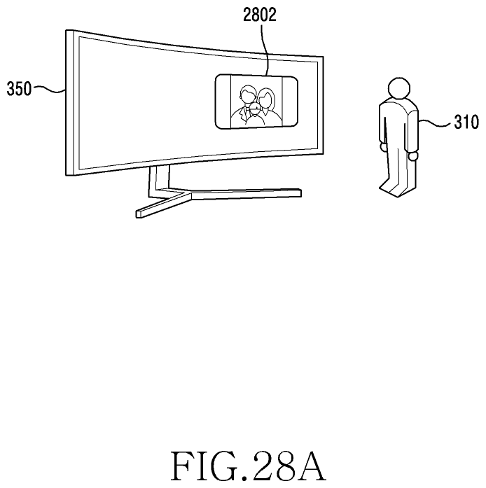

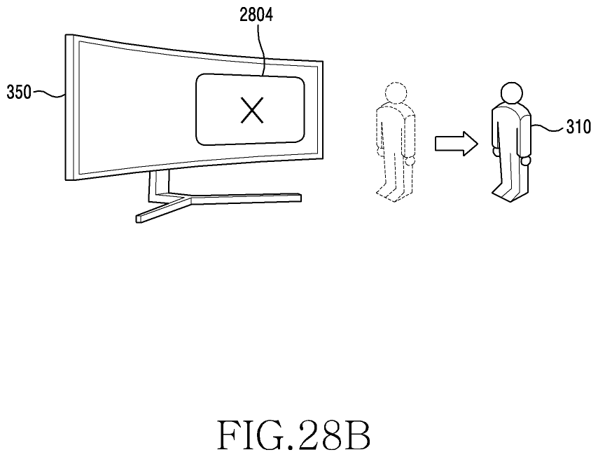

FIG. 28A and FIG. 28B are diagrams illustrating an example of a change of the displaying or non-displaying of a content displayed in a display device according to various embodiments. FIG. 28A and FIG. 28B exemplify a situation in which the displaying or non-displaying of the content is changed depending on a distance between the speechmaker 310 and the display device 350 in a public place. Referring to FIG. 28A and FIG. 28B, the display device 350 can display a content including a photo. Because the photo can be a private content, the display device 350 can control displaying or non-displaying according to a characteristic of a place where the display device 350 is installed. In response to the distance between the display device 350 and the speechmaker 310 being closer than a specified distance as in FIG. 28A, a content 2802 can be displayed. However, in response to the distance between the display device 350 and the speechmaker 310 being farther than the specified distance as in FIG. 28B, a content 2804 of a blank state can be displayed so as to prevent a situation in which the content 2802 is exposed to other people.

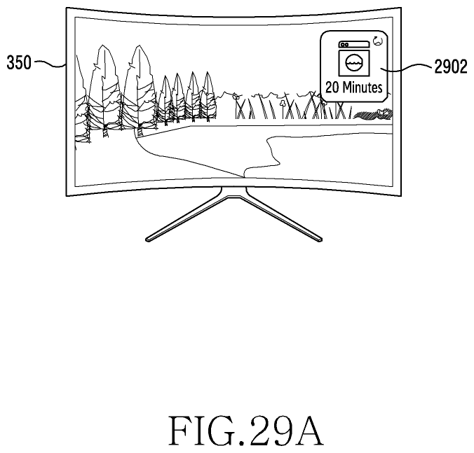

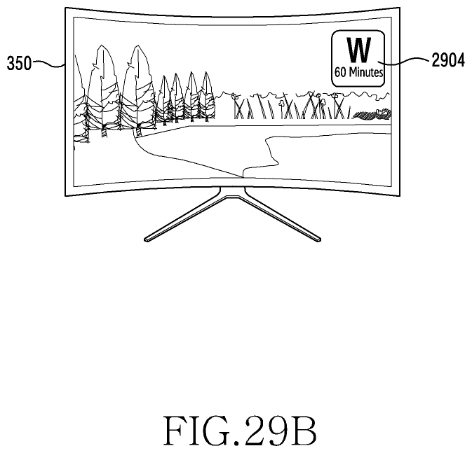

FIG. 29A and FIG. 29B are diagrams illustrating an example of a content including identification information about a source according to various embodiments. FIG. 29A and FIG. 29B exemplify the displaying of a content including identification information indicating a source of the content, in order to facilitate the recognition of the speechmaker 310 for a response. FIG. 29A illustrates a state in which a content 2902 notifying a remaining washing time is displayed in the display device 350 as an utterance sentence “Let me know how long washing time remains” is received by a speech receiving device (e.g., the speech receiving device of FIG. 3). At this time, the content 2902 can include a representative icon of a washing machine. When an icon representing a source device has not been defined, as in FIG. 29B, for example, a content 2904 including an alphabet concerning the source device can be displayed.

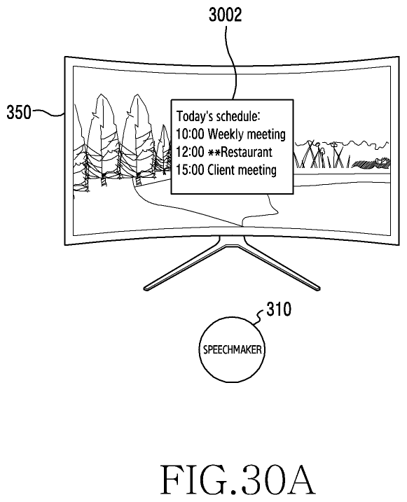

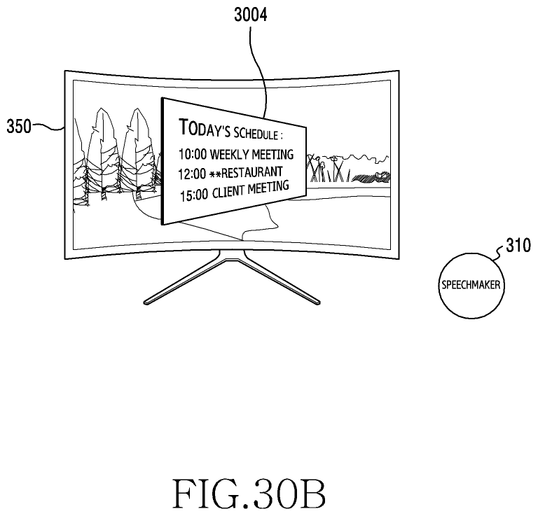

FIG. 30A and FIG. 30B are diagrams illustrating an example of a change of a content considering an angle with a speechmaker according to various embodiments. FIG. 30A and FIG. 30B exemplify a situation in which a shape of a content is changed according to the direction of the speechmaker 310 with respect to the display device 350. Referring to FIG. 30A and FIG. 30B, the display device 350 can display a content notifying a schedule. As in FIG. 30A, in response to the speechmaker 310 being located in front of the display device 350, a content 3002 of a non-transform state can be displayed. However, as in FIG. 30B, in response to the speechmaker being located at the side of the display device 350, a content 3004 of a state being deformed to facilitate observation at the location of the speechmaker 310 can be displayed.

In an embodiment described with reference to FIG. 30A and FIG. 30B, a content can be deformed according to the location of the speechmaker 310. In accordance with another embodiment, a shape of the content is maintained according to the location of the speechmaker 310, and the displaying location of the content can be adjusted. For example, the content can be displayed in a location closer to the speechmaker 310 on a screen of the display device 350. In another example, in response to the display device 350 having a curved display, the content can be displayed in a location having an angle at which the speechmaker 310 is easy to observe, on a screen of the display device 350 (e.g., when the speechmaker 310 is located to the left, the content is displayed to the right of the screen).

As in various embodiments described above, a content displayed in the display device 350 can be displayed according to a displaying scheme determined according to the state of the speechmaker 310, the states of the surroundings, or the properties of the content. In accordance with various embodiments, after the content is displayed according to the displaying scheme being based on a state or condition of when receiving an utterance sentence, the displaying scheme can be changed by a future additional action.

In accordance with an embodiment, in response to not being able to measure a distance, the display device 350 can display a content in the form of the simplest displaying level, and can display the content at a more detailed displaying level than when an additional action of the speechmaker 310 is provided. For example, in response to not being able to measure the distance with the speechmaker 310, after displaying the content at a displaying level aiming at an image or graphic easy to be recognized, the display device 350 can additionally display concrete contents, the entire data, or the entire message according to an additional action of the speechmaker 310. The additional action can include an express speech command, button touch, or touch input requesting for displaying.

In accordance with another embodiment, in response to not being able to select a display device which will display a content, or selecting a display device located distant, the display device 350 can preferably display the content at a displaying level of a high recognition ability and, in response to an additional action of the speechmaker 310 being obtained, display the entire content. That is, in response to not being capable of specifying the location of the speechmaker 310, or a content being displayed in a display device located most distant among a plurality of display devices, the content can be displayed preferably at a UI of a displaying level easy to be recognized, in other words, at the simplest displaying level, and concrete contents, the entire data, or the entire message can be displayed according to an additional action.

As in various embodiments described above, a plurality of displaying levels can be defined, and a content of any one displaying level can be displayed according to a state and a condition. For this, in an example, a content per level can be previously defined. In this case, the content per level can be previously stored in a source device having a content. In another example, a content dependent on a level can be provided according to need. In this case, an importance indication is allocated for each item included in the content and, by using the importance indication, the source device can provide a content corresponding to a specified displaying level.

In accordance with various embodiments, when a displaying level is determined, a peripheral situation can be reflected as follows. For example, displaying or non-displaying can be determined according to the peripheral situation, or the displaying level can be adjusted. Context information about the peripheral situation can include information such as the surroundings of the speechmaker 310, a preference, the situation of a device, or the situation of a peripheral device. The reflection of the context information can be performed based on information acquired through a context engine implemented in the device control server 330.

In accordance with an embodiment, in response to the display device 350 being turned off, a content can be displayed small at a lower end by using an audio return channel (ARC)/frame TV.

In accordance with another embodiment, a user may want to receive a feedback differently according to an importance of information and a context of the user. By reflecting this, in response to the display device 350 being a TV, and being turned on, a content can be displayed in a scheme of minimizing disturbances to TV watching. On the other hand, in response to the display device 350 being turned off, the content can be displayed to maintain a notification maximally.

In accordance with another embodiment, by considering that it may not be desirable that a content is too large or luxurious at a night time zone, audio output or non-output and a volume can be adjusted, in response to including a color distribution of a content, a degree of change, and/or an audio according to a time zone. In an embodiment, in response to a content including an important warning message, the content can be displayed even though it is late night. In another embodiment, in response to a content including a general message, the content may not be displayed when it is late night.

In accordance with a further embodiment, a content can be controlled according to a companion located in the vicinities of the speechmaker 310. For example, when a companion sensitive to a sound such as a baby exists, audio output or non-output and a volume can be adjusted. In another example, when a content including sensitive private information exists, the content is not displayed, or can be displayed after the displaying of a warning phrase, in response to a situation not determined to be alone only (e.g., a situation in which voices of two or more persons are obtained).

In accordance with a yet another embodiment, a device which will display a content can be selected based on a feature of a user or speechmaker. For example, a display device capable of effectively showing a content intended to be displayed can be selected based on user's setting or a user's characteristic. In accordance with an embodiment, it can be effective in that when a user or speechmaker is an aged person, the aged person prefers a generally large screen or an image expresses a content. In this case, when the closest device (e.g., monitor) has a small display, a content can be offered through a device (e.g., TV) having a larger display even though it is a little distant.

As described above, a content can be controlled according to various peripheral situations (e.g., the state of the display device 3500, an importance of information, a context of a user, a time zone, the existence or non-existence of a companion and/or the state of the companion). In accordance with various embodiments, a combination of two or more conditions among conditions on the enumerated peripheral situations can be applied to control a content. In this case, two or more conditions can be given a mutually different weight. For example, when a condition on a time zone and a condition on a companion are combined, the time zone can be given a larger weight

According to various embodiments, an operating method of an electronic device (e.g., the device control server 330) can include receiving information relating to the contents of a speechmaker (e.g., the speechmaker 310)'s speech command acquired by an external electronic device (e.g., the speech receiving device 320), and searching the vicinities of the speechmaker for one or more display devices based on the location of the speechmaker determined by using measurement information concerning the speech command, and the location of the external electronic device, and determining, from the one or more display devices, a display device (e.g., the display device 350) to display a content as a response to the speech command, and controlling the determined display device to display the content. A displaying level of the content can be determined based on at least one of the speechmaker (e.g., the speechmaker 310)'s state, the states of the speechmaker's surroundings, and the properties of the content.

According to various embodiments, searching the vicinities of the speechmaker (e.g., the speechmaker 310) for the one or more display devices can include searching the vicinities of the speechmaker for the one or more display devices by using location information of a plurality of devices included in account information stored in the electronic device (e.g., the device control server 330).

According to various embodiments, the method can further include receiving information about a reception strength and reception angle of the speech command from the external electronic device (e.g., the speech receiving device 320), and estimating the location of the speechmaker (e.g., the speechmaker 310) based on the reception strength and the reception angle.

According to various embodiments, searching the vicinities of the speechmaker (e.g., the speechmaker 310) for the one or more display devices can include searching for the one or more display devices by identifying one or more devices having a display function, among one or more devices having account information including location information which indicates being located in the same space as a space indicated by location information included in account information of the external electronic device (e.g., the speech receiving device 320).

According to various embodiments, determining the display device to display the content can include determining the display device which will display the content based on one of a measurement result of a wireless signal for the one or more display devices, or a measurement result concerning the speech command.

According to various embodiments, controlling the display device (e.g., the display device 350) to display the content can include transmitting a first indication message for offering of the content to a source device concerning the content, and transmitting a second indication message for displaying of the content to the display device.

According to various embodiments, controlling the display device (e.g., the display device 350) to display the content can include determining the displaying level of the content based on at least one of the speechmaker (e.g., the speechmaker 310)'s state, the states of the speechmaker's surroundings, or the properties of the content, and transmitting information about the displaying level to the display device or a source device having the content.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above. It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a communication module;
a processor operably connected to the communication module; and
a memory operably connected to the processor,
wherein the memory stores instructions which, when executed, cause the processor to:
receive, through the communication module, information relating to the contents of a speechmaker's speech command acquired by an external electronic device;
search the vicinities of the speechmaker for one or more display devices based on the location of the speechmaker determined by using measurement information concerning the speech command, and the location of the external electronic device;
determine, from the one or more display devices, a display device to display a content as a response to the speech command; and
display the content through the determined display device based on at least one of the speechmaker's state, the states of the speechmaker's surroundings, and the properties of the content.

2. The electronic device of claim 1, wherein the memory stores account information about a plurality of devices, and
the instructions cause the processor to search the vicinities of the speechmaker for the one or more display devices by using location information of the plurality of devices comprised in the account information.

3. The electronic device of claim 1, wherein the instructions cause the processor to, by using the communication module, receive information about a reception strength and reception angle of the speech command from the external electronic device, and estimate the location of the speechmaker based on the reception strength and the reception angle.

4. The electronic device of claim 1, wherein the instructions cause the processor to search for the one or more display devices by identifying one or more devices having a display function, among one or more devices having account information comprising location information which indicates being located in the same space as a space indicated by location information comprised in account information of the external electronic device.

5. The electronic device of claim 1, wherein the instructions cause the processor to determine the display device which will display a content based on one of a measurement result of a wireless signal for the one or more display devices, or a measurement result concerning the speech command.

6. The electronic device of claim 1, wherein the instructions cause the processor to, by using the communication module, transmit a first indication message for offering of the content to a source device concerning the content, and transmit a second indication message for displaying of the content to the display device.

7. The electronic device of claim 1, wherein the instructions cause the processor to determine a displaying level of the content based on at least one of the speechmaker's state, the states of the speechmaker's surroundings, or the properties of the content, and transmit information about the displaying level to the display device or a source device having the content.

8. (canceled)

9. An operating method of an electronic device, the method comprising:
receiving information relating to the contents of a speechmaker's speech command acquired by an external electronic device;
searching the vicinities of the speechmaker for one or more display devices based on the location of the speechmaker determined by using measurement information concerning the speech command, and the location of the external electronic device;
determining, from the one or more display devices, a display device to display a content as a response to the speech command; and
controlling the determined display device to display the content,
wherein a displaying level of the content is determined based on at least one of the speechmaker's state, the states of the speechmaker's surroundings, and the properties of the content.

10. The method of claim 9, wherein searching the vicinities of the speechmaker for the one or more display devices comprises searching the vicinities of the speechmaker for the one or more display devices by using location information of a plurality of devices comprised in account information stored in the electronic device.

11. The method of claim 9, further comprising:
receiving information about a reception strength and reception angle of the speech command from the external electronic device; and
estimating the location of the speechmaker based on the reception strength and the reception angle.

12. The method of claim 9, wherein searching the vicinities of the speechmaker for the one or more display devices comprises searching for the one or more display devices by identifying one or more devices having a display function, among one or more devices having account information comprising location information which indicates being located in the same space as a space indicated by location information comprised in account information of the external electronic device.

13. The method of claim 9, wherein determining the display device to display the content comprises determining the display device which will display the content based on one of a measurement result of a wireless signal for the one or more display devices, or a measurement result concerning the speech command.

14. The method of claim 9, wherein controlling the display device to display the content comprises:
transmitting a first indication message for offering of the content to a source device concerning the content; and
transmitting a second indication message for displaying of the content to the display device.

15. The method of claim 9, wherein controlling the display device to display the content comprises:
determining the displaying level of the content based on at least one of the speechmaker's state, the states of the speechmaker's surroundings, or the properties of the content; and
transmitting information about the displaying level to the display device or a source device having the content.

16. An electronic device comprising:
a display;
a communication module;
a processor operably connected to the display and the communication module; and
a memory operably connected to the processor,
wherein the memory stores instructions which, when executed, cause the processor to:
receive an indication message for displaying of a content and the content as a response to a speechmaker's speech command acquired by an external device; and
display the content based on at least one of the speechmaker's state, the states of the speechmaker's surroundings, and the properties of the content, through the display, based on the indication message.

17. The electronic device of claim 16, wherein the instructions cause the processor to determine a size of the content according to a distance between the speechmaker and the display device.

18. The electronic device of claim 16, wherein the instructions cause the processor to determine a rate of items constructing the content according to a distance between the speechmaker and the display device.

19. The electronic device of claim 16, wherein the instructions cause the processor to determine a size of the content according to a movement speed of the speechmaker.

20. The electronic device of claim 16, wherein the instructions cause the processor to deform the content according to a location of the speechmaker with respect to the display device.

21. The electronic device of claim 16, wherein the instructions cause the processor to change a displaying level of the content, on basis of a feedback of the speechmaker sensed after the content is displayed.
